(19) United States
(12) Patent Application Publication
(10) Pub. No.: US 2001/0006420 A1
(43) Pub. Date: Jul. 5, 2001

(54) Laser measuring device and laser measuring method

(75) Inventor: Yoshikazu Kato, Tokyo (JP)

Correspondence Address: Norman P. Soloway, HAYES, SOLOWAY, HENNESSEY, GROSSMAN & HAGE P.C., 175 Canal Street, Manchester, NH, 03101, US

(73) Assignee: NEC Corporation

(21) Appl. No.: 09/733,251

(22) Filed: Dec. 8, 2000

(30) Foreign Application Priority Data
Dec. 10, 1999 (JP) 352016/1999

(51) Int. Cl. G01B 9/02

(52) U.S. Cl. 356/498; 356/510

(57) ABSTRACT

A laser measuring method is provided, which suppress the shift or change of laser beams traveling toward an optical detector even if a displacement error (i.e., yawing and/or pitching) of an object to be measured occurs. This method is comprised of (a) forming a laser beam on a first member; (b) splitting the laser beam into incident laser sub-beams on the first member; (c) reflecting the respective incident sub-beams by a first plurality of optical reflectors mounted on a second member, forming a first plurality of reflected sub-beams; the second member being apart from the first member; (d) reflecting the first plurality of reflected sub-beams by a second optical reflector mounted on the first member, forming a second plurality of reflected sub-beams toward the first plurality of optical reflectors; (e) reflecting the second plurality of reflected sub-beams by the first plurality of optical reflectors, forming a third plurality of reflected sub-beams toward the beam splitter; the third plurality of reflected sub-beams traveling along optical paths of the respective incident laser sub-beams; and (f) detecting the third plurality of laser sub-beams by an optical detector mounted on the first member. Each of the first plurality of optical reflectors is preferably formed by a prism, a mirror, and a corner cube prism.

### BACKGROUND OF THE INVENTION

1. Field of the Invention

The present invention relates to a laser measuring device and a laser measuring method and more particularly, to a device for measuring the displacement and/or displacemient error (e.g., the yawing angle and/or the pitching angle) of a movable or moving object using the optical path difference of laser beam or sub-beams.

2. Description of the Related Art

Generally, large-sized machine tools (e.g. milling machines and numerically controlled (NC) machine tools) and electron-beam exposure apparatuses used for semiconductor device manufacturing are equipped with a table or stage movable or displaceable in a specific direction. Laser measuring devices are used to accurately measure the displacement and/or the displacement error of the table or stage.

FIG. 1 shows an example of the prior-art laser measuring devices of this type, which measures the yawing angle of a movable object known as one of the displacement errors.

As shown in FIG. 1, the prior-art laser measuring device 200 comprises a laser souroe 203, two polarized beam splitters 204a and 204b, two corner cube prisms 208a and 208b, and an optical receiver or detector 209.

The laser source 203 generates an initial laser beam. Each of the polarized beam splitters 204a and 204b allows the horizontally polarized component of its incident light beam to pass through and at the same time, reflects the vertically polarized component of the same beam in a direction perpendicular to its incident direction. Each of the corner cube prisms 208a and 208b reflects its incident light beam in a direction parallel to its incident direction. The optical receiver or detector 209 detects the intensity of its incident light beam.

The laser source 203, the beam splitters 204a and 204b, and the optical detector 209 are mounted on a table 230 fixed to a specific position. On the other hand, the corner cube prisms 208a and 208b are attached on the surface 220a of an object 220 movable in the direction denoted by M by way of supporting members 215a and 215b, respectively. The surface 220a of the object 220 is a target surface to be measured. The object 220 is, for example, a stage designed to be movable along a single axis with respect to the fixed table 230. The object 220 is apart from the table 230 in the M direction by a specific distance.

Here, the Z and X axes are defined on the surface of the table 230, as shown in FIG. 1. The Z axis is parallel to the M direction. The X axis is perpendicular to the Z axis.

The laser source 203 is mounted on the table 230 at the specific location in such a way that the beam emission direction is perpendicular to the target surface 220a of the object 220. The source 203 emits a laser beam L200 containing the vertically polarized component and the horizontally polarized component toward the target surface 220a. The beam L200 travels along the Z axis. The surface 220a is parallel to the X axis.

The beam splitter 204a is apart from the laser source 203 and aligned to the same along the Z axis. The splitter 204a is located on the optical path of the beam L200 along the Z axis. The splitter 204a allows the horizontally polarized component of the beam L200 to pass through the splitter 204a in the +Z direction toward the object 220 without changing its direction. At the same time, the splitter 204a reflects the vertically polarized component of the beam L200 and turns it to the +X direction toward the splitter 204b. Thus, the splitter 204a splits the beam L200 into a sub-beam L201 traveling in the +Z direction and a sub-beam L202 traveling in the +X direction.

Moreover, the beam splitter 204a allows a reflected sub-beam L201 by the corner cube prism 208a to pass through the same without changing its direction toward the detector 209. At the same time, the splitter 204a reflects a reflected sub-beam L202′ traveling in the −X direction, which has been reflected by the corner cube prism 208b and the beam splitter 204b, and turns it to the −Z direction toward the detector 209.

The beam splitter 204b is apart from the beam splitter 204a and the laser source 203 and is aligned to the splitter 204a along the X axis. The splitter 204b is located on the optical path of the sub-beam L202 emitted from the splitter 204a in the +X direction. The splitter 204b reflects the sub-beam L202 thus emitted and turns it to the +Z direction toward the object 220. Also, the splitter 204b reflects the sub-beam L202′ traveling in the −Z direction, which has been reflected by the corner cube prism 208b, and turns it to the −X direction toward the splitter 204a.

The corner cube prism 208a has a pair of reflection planes 213a and 214a perpendicular to each other. Each of the planes 213a and 214a is at an angle of 45°with respect to the Z axis. The plane 213a is located on the optical path of the sub-beam L201 emitted from the splitter 204a. The prism 208a reflects the sub-beam L201 and turns it to the −Z direction with the planes 213a and 214a, forming the reflected sub-beam L201′. The plane 213b is located on the optical path of the sub-beam L201′.

The corner cube prism 208b is apart from the prism 208a at a specific distance d200 and aligned with the same along the X axis. The prism 208b has a pair of reflection planes 213b and 214b perpendicular to each other. Each of the planes 213b and 214b is at an angle of 45°with respect to the Z axis. The plane 213b is located on the optical path of the sub-beam L202 emitted from the splitter 204b. The prism 208b reflects the sub-beam L202 and turns it to the −Z direction with the planes 213b and 214b, forming the reflected sub-beam L202′. The plane 214b is located on the optical path of the sub-beam L202′.

Thus, the sub-beams L201 and L202 travel in the +Z direction and the reflected sub-beams L201′ and L202′ travel in the opposite direction to the sub-beams L201 and L202 (i . e., in the −Z direction).

The optical detector 209 is located near the laser source 203 and the beam splitter 204a in such a way that the reception surface of the detector 209 faces the beam splitter 204a. The reception surface of the detector 209 is located on the optical paths of the reflected sub-beams L201′ and L202′ emitted from the splitter 204a. The detector 209 detects the intensity of the sub-beams L201′ and L202′.

The prior-art laser measuring device 200 having the above-described configuration operates in the following way.

The initial laser beam L200 emitted by the laser source 203 enters the beam splitter 204a and then, the beam L200 is split into the two sub-beams L201 and L202 by the splitter 204a. The sub-beam L201 is emitted from the splitter 204a in the +Z direction toward the corner cube prism 203a. The sub-beam L202 is emitted from the splitter 204a in the +X direction toward the beam splitter 204b.

The sub-beam L201 emitted from the splitter 204a in the +Z direction enters the corner cube prism 209a on the object 220. In the prism 208a, the sub-beam L201 is turned to the +X direction by the reflection plane 213a and then, turned again to the −Z direction by the reflection plane 214a, forming the reflected sub-beam L201′ traveling in the −Z direction. The reflected sub-beam L201′ enters the beam splitter 204a and passes through the same without changing its direction, entering the optical detector 209.

The sub-beam L202 emitted from the splitter 204a in the +X direction enters the beam splitter 204b. Then, the sub-beam L202 is reflected by the splitter 204b to be turned to the +Z direction, entering the corner cube prism 208b on the object 220. In the prism 208b, the sub-beam L202 is turned to the +X direction by the reflection plane 213b and then, turned again to the −Z direction by the reflection plane 214b, forming the reflected sub-beam L202′ traveling in the −Z direction. The reflected sub-beam L202′ enters the beam splitter 204b. The sub-beam L202′ is turned to the −X direction by the splitter 204b and emitted toward the splitter 204a. The sub-beam L202′ is further turned to the −Z direction by the splitter 204a, entering the detector 209.

The sum of the optical paths of the incident sub-beam L201 and the reflected sub-beam L201′ (which is defined as the first overall optical path) is different from the sum of the optical paths of the incident sub-beam L202 and the reflected sub-beam L202′ (which is defined as the second overall optical path). Thus, optical interference occurs between the reflected sub-beams L201′ and L202′, causing some change or fluctuation of the intensity of the interference beam. The intensity of the interference beam varies according to the length difference between the first and second overall optical paths. As a result, the yawing or pitching angle of the object 220 with respect to the table 230 can be measured.

For example, as shown in FIG. 2, it is supposed that some yawing of the object 220 occurs around the axis C201 on the object 220 perpendicular to the X-Z plane during a translational motion of the object 220 in the M direction. In this case, the difference between the first and second overall optical path lengths increases and as a result, the intensity of the interference beam detected by the detector 209 varies. Thus, the yawing angle of the object 220 can be calculated by a known method on the basis of the intensity change of the interference beam.

If the object 220 is moved around an axis parallel to the X axis, some pitching of the object 220 occurs. In this case, the combination of the laser source 203, the beam splitters 204a and 204b, the corner cube prisms 208a and 208b, and the optical detector 209 needs to be rotated by 90°around an axis perpendicular to the surface 220a of the object 220. Then, the pitching angle of the object 220 can be calculated on the basis of the intensity change of the interference beam in the same way as above.

With the above-described prior-art laser measuring device 200 shown in FIG. 1, there is a problem that the yawing or pitching angle is unable to be measured or found if the yawing or pitching angle is considerably large (e.g., ±10°or greater). This is due to the narrow measurable range for the yawing or pitching angle in the device 200. According to the inventor's research, the measurable range is ±100 at the maximum in known laser measuring devices of this type that have been commercially provided so far. This problem will be explained in detail below.

For example, if specific yawing of the object 220 occurs around the axis C201 at a yawing angle of 2°, as shown in FIG. 2, the direction of the reflected sub-beams L201′ and L202′ shifts toward the +X direction (i.e., toward the right-hand side in FIG. 2) with respect to their initial or reference position. In this case, the yawing angle is as small as 2°and the shifting of the sub-beams L201′ and L202′ is small and therefore, both the sub-beams L201′ and ′ L202′ can enter the detector 209.

However, if specific yawing of the object 220 occurs around the axis C201 at a yawing angle of 4°, as shown in FIG. 3, the directional shift of the reflected sub-beams L201′ and L202′ toward the +X direction becomes excessively large. As a result, the shifting distance of the sub-beams L201′ and L202′ is excessive and therefore, both the sub-beams L201′ and L202′ are unable to enter the detector 209. This means that the yawing angle cannot be found or measured.

Needless to say, if the position of the detector 209 is readjusted so that both the sub-beams L201′ and L202′ enter the detector 209, the measurement will be possible. In this case, however, there arises another problem that the measurement time becomes longer, because an extra time is necessary for the positional readjustment of the detector 209.

Furthermore, even if the yawing angle is as small as 2°, the same problem may occur. Specifically, as shown in FIG. 4, if specific yawing takes place around an axis C202 apart from the corner cube prisms 208a and 208b at a considerable distance (i.e., the axis C202 is outside the object 220), the directional shift of the reflected sub-beams L201′ and L202′ toward the +X direction becomes excessively large. As a result, like the case where the yawing angle is 4°shown in FIG. 3, the shifting distance of the sub-beams L201′ and L202′ is excessive and therefore, both the sub-beams L201′ and L202′ are unable to enter the detector 209 as well.

In particular, if the rotation center of the object 220 (i.e., the yawing center) is unknown, the measuring process needs to be repeated several times in order to estimate the position of the rotation center. Thereafter, the position of the prisms 200a and 208b needs to be readjusted at or near the estimated rotation center. As a result, it takes very long time for the positional readjustment of the prisms 208a and 208b, which makes the measuring time very longer as well.

Moreover, if the estimated rotation renter of the object 220 (i.e., the yawing center) is located outside the object 220, for example, an additional rigid plate needs to be attached to the object 220 for the purpose of supporting the prisms 208a and 208b on the object 220. In this case, however, there may be a problem that the measurement is not accurate. This is because some flexure or sag tends to occur in the additional plate itself due to its own weight.

On the other hand, to raise or improve the measurement accuracy of the yawing angle, the resolving power needs to be enhanced. To realize this, for example, it is sufficient that the distance d200 between the prisms 208a and 208b is simply increased to the distance d200′, as shown by a prior-art laser measuring device 200A in FIG. 5. However, the increased distance d200′ between the prisms 208a and 208b will increase the shifting distance of the reflected sub-beats L201′ and L202′ from their initial position.

Thus, if the increased distance d200′ is excessively large, at least one of the sub-beams L201′ and L202′ will be easily off the detector 209 due to yawing at a small angle as small as 2°, as shown in FIG. 5. As a result, the permissible range of the distance d200 is limited, which limits the resolving power in measurement.

It is needless to say what the above-described problem occurs with respect to the pitching angle measurement.

In the measurement of displacement of the object 220, if the displacement of the object takes place along with some yawing and/or pitching, there is a similar problem that the laser sub-beams will not enter the optical detector 209, resulting in the measurement itself being impossible.

The Japanese Non-Examined Patent Publication No. 62-55501 published in 1987 discloses a laser measuring device comprising a coherent light source for emitting a light beam, optical systems for producing interfered beams, and an optical detector for detecting the interfered beams. Each of the optical systems irradiates part of the light beam emitted from the source to a corresponding object to be measured and then, mixes the reflected light beams by the object, thereby producing the interfered beams. The optical systems are selectable for switching the objects. Thus, the laser measuring device is capable of measuring the displacement of each object or relative displacement between the desired ones of the objects according to the necessity.

The Japanese Non-Examined Patent Publication No. 2-297010 published in 1990 discloses a laser measuring device having a similar configuration as the prior-art device 200 shown in FIG. 1. This device makes it possible to measure the length of an object or its part with high accuracy even if the object is tilted at an angle.

The Japanese Non-Examined Patent Publication No. 9-5018 published in 1997 discloses a laser measuring device comprising a laser source, a beam splitter, a movable mirror means attached to an object, a fixed mirror means mounted on a fixed table, and an optical detector. The beam splitter splits a laser beam emitted from the laser source into two sub-beams, forming a measuring laser beam and a reference laser beam. The measuring laser beam is irradiated to the movable mirror means, forming a reflected measuring laser beam. The reference laser beam is irradiated to the fixed mirror means, forming a reflected reference laser beam. The optical detector receives the reflected measuring laser beam and the reflected reference laser beam and detects the displacement distance of the object on the basis of the difference between the optical path lengths of the reflected measuring and reference beams.

The Japanese Non-Examined Patent Publication No. 10-2720 published in 1998 discloses a laser measuring device having a similar configuration as the device disclosed in the above-identified Publication No. 9-5018. This device has a stabilization means for stabilizing the output laser beam of a laser source by adjusting the amount of the light fed back to the source.

However, the above-described prior-art devices disclosed in the Publication Nos. 62-55501, 2-297010, 9-5018, and 10-2720 do not disclose the technique for measuring the yawing or pitching angle.

Also, the above-described prior-art device disclosed in the Publication No. 2-297010 has a problem that the reflected light beam may not enter the optical detector if the tilt angle of the object is considerably large (in other words, the yawing or pitching angle is considerably large). This is similar to the prior-art device 200 shown in FIG. 1.

### SUMMARY OF THE INVENTION

Accordingly, an object of the present invention is to provide a laser measuring device and a laser measuring method that suppress or eliminate the shift or change of laser beams traveling toward an optical detector even if displacement error (i.e., yawing and/or pitching) of an object to be measured occurs.

Another object of the present invention is to provide a laser teasuring device and a laser measuring method capable of stable measuring operation even if displacement error (i.e., yawing and/or pitching) of an object to be measured is large.

Still another objecot of the present invention is to provide a laser measuring device and a laser measuring method that reduce the measuring time.

A further object of the present invention is to provide a laser measuring device and a laser measuring method that enhance the resolving power in measurement,

The above objects together with others not specifically mentioned will become clear to those skilled in the art from the following description.

According to a first aspect of the present invention, a laser measuring device is provided, which is for optically measuring a displacement, or a yawing or pitching angle of a member with respect to another member with a laser beam.

The device comprises:

(a) a laser source for emitting a laser beam; the laser source designed to be mounted on a first member;

(b) a beam splitter for splitting the laser beam into incident laser sub-beams;

the beam splitter designed to be mounted on the first member;

(c) a first plurality of optical reflectors for reflecting the respective incident sub-beams from the beam splitter to form a first plurality of reflected sub-beams;

the first plurality of optical reflectors being designed to be mounted on a second member;

the second member being apart from the first member;

(d) a second optical reflector for reflecting the first plurality of reflected sub-beams to form a second plurality of reflected sub-beaini toward the first plurality of optical reflectors;

the second optical reflector being designed to be mounted on the first member;

the second plurality of reflected sub-beams being reflected by the first plurality of optical reflectors to form a third plurality of reflected sub-beams toward the beam splitter;

the third plurality of reflected sub-beams traveling along optical paths of the respective incident laser sub-beams; and

(e) an optical detector for detecting the third plurality of laser sub-beams;

the detector being designed to be mounted on the first member.

With the laser measuring device according to the first aspect of the present invention, the beam splitruer splits the laser beam from the laser source into the incident laser sub-beams on the first member. The first plurality of optical reflectors mocunted on the second member reflect the respective incident sub-beams thus formed, forming the first plurality of reflected sub-beams.

Then, the second optical reflector mounted on the first member reflects the first plurality of reflected sub-beams thus formed, forming the second plurality of reflected sub-beams toward the first plurality of optical reflectors. The second plurality of reflected sub-beams are reflected by the first plurality of optical reflectors, forming the third plurality of reflected sub-beams toward the beam splitter. The third plurality of reflected sub-beams thus formed travel along the optical paths of the respective incident laser sub-beams and then, detected by the optical detector mounted on the first member.

Accordingly, even if a displacement error such as yawing or pitching occurs in the second member, the third plurality of reflected sub-beams emitted from she first plurality of optical refrectors enter the detector in the same way as the case where no displacement error occurs. As a result, the shift or change of the third plurality of reflected sub-beams traveling toward the detector can be eliminated or suppressed even if a displacement error of the second member exists.

Also, the shift or change of the third plurality of reflected sub-beams traveling toward the detector can be eliminated or suppressed and therefore, even if a large displacement error of the second member occurs, the third plurality of reflected sub-beams can be surely received by the detector.

Since the positional adjustment of the optical detector required in the prior-art laser measuring device is unnecessary, the measurement time is reduced.

Moreover, it can be said that each of the incident sub-beams makes a round trip along the optical path between the beam splitter and the second optical reflector by way of the first plurality of optical reflectors. Accordingly, the difference between the optical path lengths between the beam splitter and the second optical reflector is twice as much as the prior-art laser measuring device, As a result, resolving power in measurement is enhanced.

In a preferred embodiment of the device according to the first aspect, each of the first plurality of optical reflectors is an optical element that reflects an incident beam and turn the incident beam to an opposite direction to the incident beam. For example, each of the first plurality of optical reflectors is preferably formed by a prism, a mirror, and a corner cube prism.

In this embodiment, it is preferred that the second optical reflector is an optical element with a flat reflecting plane, and that the second plurality of reflected sub-beams travel in an opposite direction to the first plurality of reflected sub-beams due to reflection on the flat reflecting plane of the optical element.

In another preferred embodiment of the device according to the first aspect, each of the first plurality of optical reflectors has a first reflecting plane that receives a corresponding one of the incident laser sub-beams from the beam splitter and a second reflecting plane that is opposed co the second optical reflector.

In still another preferred embodiment of the device according to the first aspect, the first plurality of reflected sub-beams formed by the first plurality of optical reflectors are incident perpendicularly on corresponding reflecting planes of the second optical reflector.

In a further preferred embodiment of the device according to the first aspect, the third plurality of reflected sub-beams toward the beam splitter are approximately coaxial with the respective incident laser sub-beams.

According to a second aspect of the present invention, a laser measuring method is provided, which corresponds to the device according to the first aspect.

The method comprises:

(a) forming a laser beam on a first member;

(b) splitting the laser beam into incident laser sub-beams on the first member;

(c) reflecting the respective incident sub-beams by a first plurality of optical reflectors mounted on a second member, forming a first plurality of reflected sub-beams;

the second member being apart from the first member;

(d) reflecting the first plurality of reflected sub-beams by a second optical reflector mounted on the first member, forming a second plurality of reflected sub-beams toward the first plurality of optical reflectors;

(e) reflecting the second plurality of reflected sub-beams by the first plurality of optical reflectors, forming a third plurality of reflected sub-beams toward the beam splitter;

the third plurality of reflected sub-beams traveling along optical paths of the respective incident laser sub-beams; and

(f) detecting the third plurality of laser sub-beams by an optical detector mounted on the first member.

With the laser measuring method according to the second aspect of the present invention, because of substantially the same reason as the device according to the first aspect, the shift or change of the third plurality of reflected sub-beams traveling toward the detector can be eliminated or suppressed even if a displacement error of the second member exists. This means that stable measuring operation is possible even if the displacement error of the second object is large.

Also, the measurement time is reduced and the resolving power in measurement is enhanced.

In a preferred embodiment of the method according to the second aspect, each of the first plurality of optical reflectors is an optical element that reflects an incident beam and turn the incident beam to an opposite direction to the incidenz beam. For example, each of the first plurality of optical reflectors is preferably formed by a prism, a mirror, and a corner cube prism.

In this embodiment, it is preferred that the second optical reflector is an optical element with a flat reflecting plane, and that the second plurality of reflected sub-beams travel in an opposite direction to the first plurality of reflected sub-beams due to reflection on the flat reflecting plane of the optical element.

In another preferred embodiment of the method according to the second aspect, each of the incident laser sub-beams from the beam splitter is reflected by a first reflecting plane of a corresponding one of the first plurality of optical reflectors. The second optical reflector is opposed to a second reflecting plane of a corresponding one of the first plurality of optical reflectors.

In still another preferred embodiment of the method according to the second aspect, the first plurality of reflected sub-beams formed by the first pluraliry of optical reflectors are incident perpendicularly on corresponding reflecting planes of the second optical reflector.

In a further preferred embodiment of the method according to the second aspect, the third plurality of reflected sub-beams toward the beam splitter are approximately coaxial with the respective incident laser sub-beams.

According to a third aspect of the present invention, another laser measuring device is provided.

The device comprises:

(a) a laser source for emitting a laser beam;

the laser source designed to be mounted on a first member;

(b) a first beam splitter for splitting the laser beam into incident laser sub-beams;

the first beam splitter designed to be mounted on the first member;

(c) a second beam splitter for directing a first one of the incident laser sub-beams to a second member;

the second beam splitter designed to be mounted on the first member;

the second member being apart from the first member;

(d) a third beam splitter for directing a second one of the incident laser sub-beams to the second member;

the third beam splitter designed to be mounted on the first member;

(e) a first optical reflector for reflecting the first one of the incident laser sub-beams to form a first reflected sub-beam;

the first optical reflector being designed to be mounted on the second member;

(f) a second optical reflector for reflecting the second one of the incident laser sub-beams to form a second reflected sub-beam;

the second optical reflector being designed to be mounted on the second member;

(g) a third optical reflector for reflecting the first and second reflected sub-beams to form third and fourth reflected sub-beams toward the first and second optical reflectors, respectively;

the third optical reflector being designed to be mounted on the first member;

the third and fourth reflected sub-beams being reflected by the first and second optical reflectors to form fifth and sixth reflected sub-beams toward the second and third beam splitters, respectively;

the fifth and sixth reflected sub-beams traveling along optical paths of the first and second ones of the incident laser sub-beams, respectively; and

(h) an optical detector for detecting the fifth and sixth laser sub-beams;

the detector being designed to be mounted on the first member.

With the laser measuring device according to the third aspect of the present invention, the first beam splitter splits the laser beam from the laser source into the incident laser sub-beams on the first member. The second beam splitter mounted on the first member directs the first one of the incident laser sub-beams to the second member. The third beam splitter mounted on the first member diirects the second one of the incident laser sub-beams to the second member.

The first optical reflector mounted on the second member reflects the first one of the incident laser sub-beams, forming the first reflected sub-beam. The second optical reflector mounted on the second member reflects the second one of the incident laser sub-beams, forming the second reflected sub-beam.

The third optical reflector mounted on the first member reflects the first and second reflecred sub-beams, forming the third and fourth reflected sub-beams toward the first and second optical reflectors, respectively. The third and fourth reflected sub-beams are reflected by the first and second optical reflectors, forming the fifth and sixth reflected sub-beams toward the second and third beam splitters, respectively.

The fifth and sixth reflected sub-beams thus formed travel along the optical paths of the first and second ones of the incident laser sub-beams, respectively, and then, detected by the optical detector mounted on the first member.

Accordingly, even if a displacement error such as yawing or pitching occurs in the second member, the fifth and sixth reflected sub-beams formed by reflection by the first and second optical reflectors enter the detector in the same way as the case where no displacement error occurs. As a result, the shift or change of the fifth and sixth reflected sub-beams can be eliminated or suppressed even if a displacement error of the second member exists.

Also, the shift or change of the fifth and sixth reflected sub-beams can be eliminated or suppressed and therefore, even if a large displacement error of the second member occurs, the fifth and sixth reflected sub-beams can be surely received by the detector.

Since the positional adjustment of the optical detector required in the prior-art laser measuring device is unnecessary, the measurement time is reduced.

Moreover, it can be said that each of the incident sub-beams makes a round trip along the optical path between the first beam splittecr and the third optical reflector by way of the fsirt and second optical reflectors. Accordingly, the difference between the optical path lengths between the first bean splitter and the third optical reflector is twice as much as the prior-art laser mea suring device. As a result, resolving power in measurement is enhanced.

In a preferred embodiment of the device according to the third aspect, each of the first and second optical reflectors is an optical element that reflects an incident beam and turn the incident beam to an opposite direction to the incident beam. For example, each of the first and second optical reflectors is preferably formed by a prism, a mirror, and a corner cube prism.

In this embodiment, it is preferred that the third optical reflector is an optical element with a flat reflecting plane, and that the third and fourth reflected sub-beams travel in an opposite direction to the first and second reflected sub-beams due to reflection on the flat reflecting plane of the optical element, respectively.

In another preferred embodiment of the device according to the third aspect, each of the first and second optical reflectors has a first reflecting plane that receives a corresponding one of the first and second ones of the incident laser sub-beams and a second reflecting plane that is opposed to the third optical reflector.

In still another preferred embodiment of the device according to the third aspect, the first and second reflected sub-beams formed respectively by the first and second optical reflectors are incident perpendicularly on corresponding reflecting planes of the third optical reflector.

In a further preferred embodiment of the device according to the third aspect, the fifth and sixth reflected sub-beams are approximately coaxial with the first and second ones of the incident laser sub-beams, respectively.

According to a fourth aspect of the present invention, another laser measuring method is provided, which corresponds to the device according to the third aspect.

The method comprises:

(a) forming a laser beam on a first member;

(b) splitting the laser beam into incident laser sub-beams on the first member;

(c) directing a first one of the incident laser sub-beams to a second member;

the second beam splitter designed to be mounted on the first member;

the second member being apart from the first member;

(d) directing a second one of the incident laser sub-beams to the second member;

the third beam splitter designed to be mounted on the first member;

(e) reflecting the first one of the incident laser sub-beams by a first optical reflector, forming a first reflected sub-beam;

the first optical reflector being mounted on the second member;

(f) reflecting the second one of the incident laser sub-beams by a second optical reflector, forming a second reflected sub-beam;

the second optical reflector being mounted on rhe second member;

(g) reflecting the first and second reflected sub-beams by a third optical reflectors forming third and fourth reflected sub-beams toward the first and second optical reflectors, respectively;

the third optical reflector being mounted on the first member;

(h) reflecting the third and fourth reflected sub-beams by the first and second optical reflectors, forming fifth and sixth reflected sub-beams toward the second and third beam splitters, respectively,

the fifth and sixth reflected sub-beams traveling along optical paths of the first and second ones of the incident laser sub-beams, respectively; and

(i) detecting the fifth and sixth laser sub-beams by an optical detector mounted on the first member.

With the laser measuring method according to the fourth aspect of the present invention, because of substantially the same reason as the device according to the third aspect, the shift or change of the fifth and sixth reflected sub-beams traveling toward the detector can be eliminated or suppressed even if a displacement error of the second member exists, This means that stable measuring operation is possible even if the displacement error of the second object is large.

Also, the measurement time is reduced and the resolving power in measurement is enhanced.

In a preferred embodiment of the method according to the fourth aspect, each of the first and second optical reflectors is an optical element that reflects an incident beam and turn the incident beam to an opposite direction to the incident beam. For example, each of the first and second optical reflectors is preferably formed by a prism, a mirror, and a corner cube prism.

Also, it is preferred that the second optical reflector is an optical element with a flat reflecting plane, and that the third and fourth reflected sub-beams travel in an opposite direction to the first and second reflected sub-beams due to reflection on the flat, reflecting plane of the optical element, respectively.

In another preferred embodiment of the method according to the fourth aspect, each of the first and second optical reflectors has a first reflecting plane that receives a corresponding one of the first and second ones of the incident laser sub-beams and a second reflecting plane that is opposed to the third optical reflector.

In still another preferred embodiment of the method according to the fourth aspect, the first and second reflected sub-beams formed respectively by the first and second optical reflectors are incident perpendicularly on corresponding reflecting planes of the third optical reflector.

In a further preferred embodiment of the method according to the fourth aspect, the fifth and sixth reflected sub-beams are approximately coaxial with the first and second ones of the incident laser sub-beams, respectively.

### BRIEF DESCRIPTION OF THE DRAWINGS

In order that the present invention may be readily carried into effect, it will now be described with reference to the accompanying drawings.

FIG. 1 is a partial, schematic plan view showing the configuration of a prior-art laser measuring device.

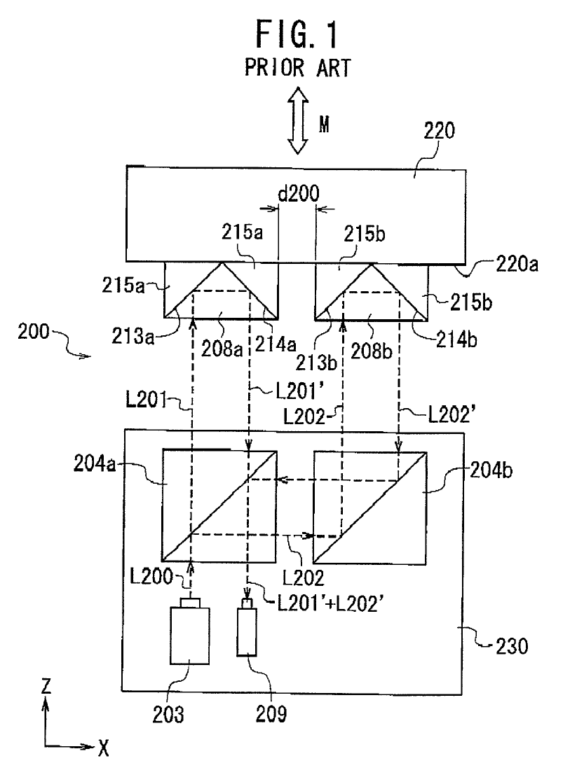

FIG. 2 is a partial, schematic plan view showing the state of the prior-art device of FIG. 1 in the measuring operation for the object displaced around an axis on the object at a yawing angle.

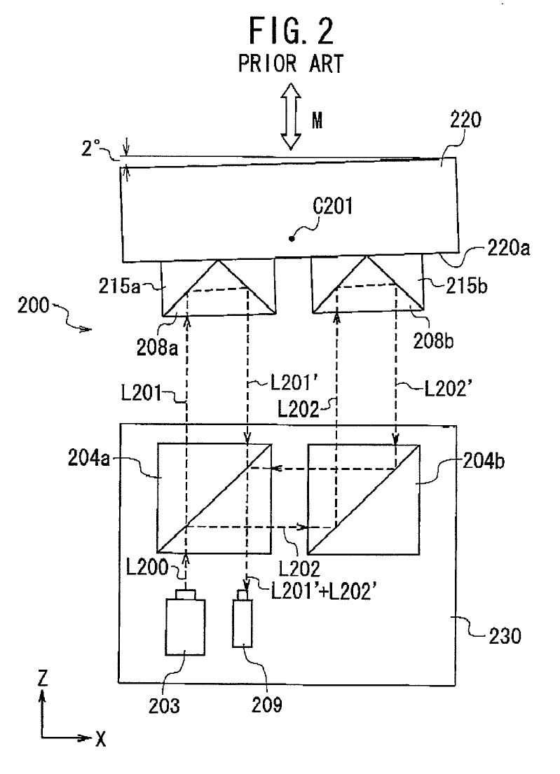

FIG. 3 is a partial, schematic plan view showing the state of the prior-art device of FIG. 1 in the measuring operation for the object displaced around an axis on the object at a larger yawing angle than that of FIG. 2.

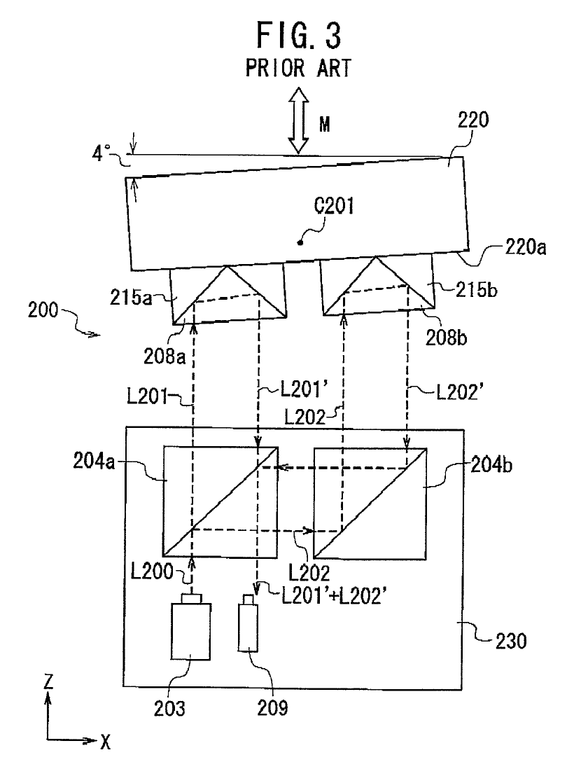

FIG. 4 is a partial, schematic plan view showing the state of the prior-art device of FIG. 1 in the measuring operation for the object displaced around an axis outside the object at a yawing angle.

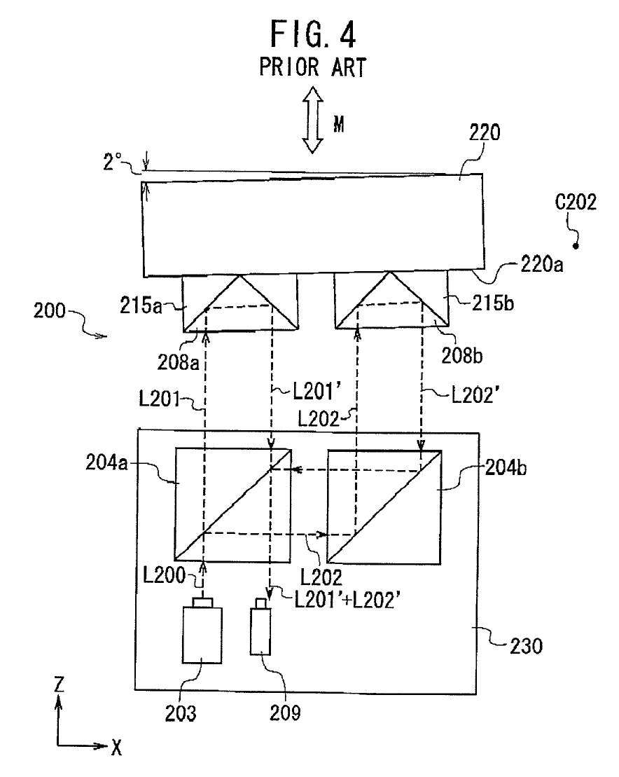

FIG. 5 is a partial, schematic plan view showing the configuration of another prior-art laser measuring device, in which the distance between the corner cube prisms on the object is greater than that of the device of FIG. 1.

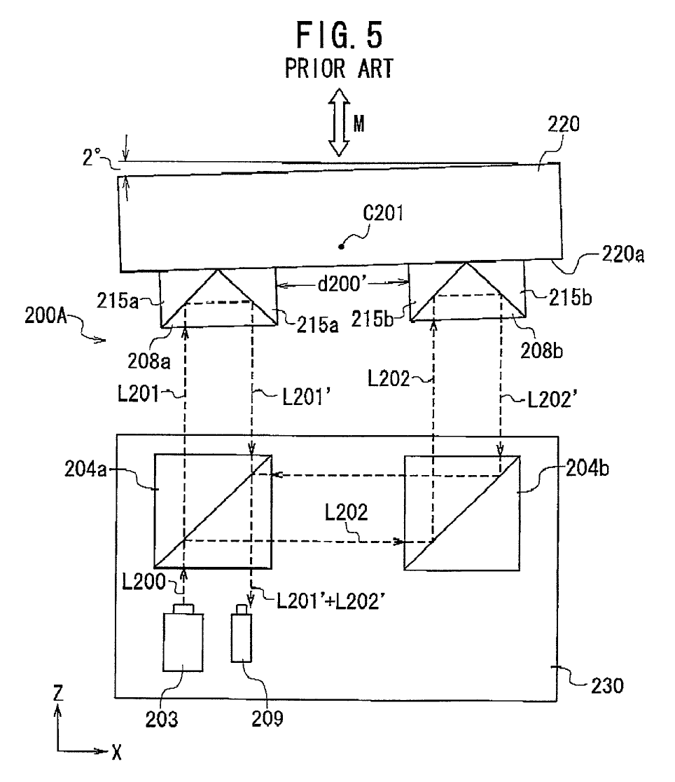

FIG. 6 is a partial, schematic plan view showing the configuration of a laser measuring device according to a first embodiment of the invention.

FIG. 7 is a partial, schematic-side view showing the configuration of a single-axis stage mechanism equipped with the laser measuring device according to the first embodiment of FIG. 6.

FIG. 8 is a partial, schematic perspective view showing the configuration of the single-axis stage mechanism shown in FIG. 7.

FIG. 9 is a partial, schematic plan view showing the state of the device according to the first embodiment of FIG. 6 in the measuring operation for the object displaced around an axis on the object at a large yawing angle.

FIG. 10 is a partial, schematic plan view showing the state of the device according to the first embodiment of FIG. 6 in the measuring operation for the object displaced around an axis outside the object at a large yawing angle.

FIG. 11 is a partial, schematic plan view showing the configuration of a laser measuring device according to a second embodiment of the invention.

FIG. 12 is a partial, schematic plan view showing the configuration of a laser measuring device according to a third emodiment of the invention.

FIG. 13 is a partial, schematic plan view showing the configuration of a laser measuring device according to a fourth embodiment of the invention.

FIG. 14 is a partial, schematic plan view showing the state of the device according to ahe fourth embodiment of FIG. 13 in the measuring operation for the object displaced around an axis on the object at a large yawing angle.

FIG. 15 is a partial, schematic plan view showing the state of the device according to the fourth embodiment of FIG. 13 in the measuring operation for the object displaced around an axis outside the object at a large yawing angle.

### DETAILED DESCRIPTION OF THE PREFERRED EMBODIMENTS

Preferred embodiments of the present invention will be described in detail below while referring to the drawings attached.

### FIRST EMBODIMENT

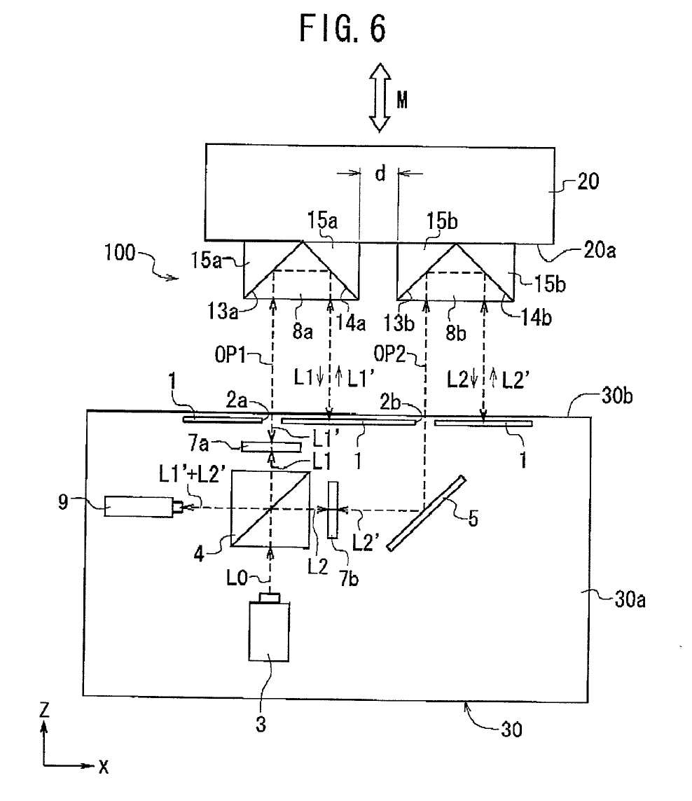

A laser measuring device according to a first embodiment of the invention has a configuration as shown in FIG. 6.

As shown in FIG. 6, the laser measuring device 100 according to the first embodiment comprises a laser source 3, a polarized beam splitter 4, two quarter-wave plates 7a and 7b, a mirror 5, a mirror 1, two corner cube prisms 8a and 8b, and an optical detector or receiver 9.

The laser source 3 generates an initial laser beam. The polarized beam splitter 4 allows the horizontally polarized component of an incident light beam to pass through and at the same time, reflects the vertically polarized component of the same incident beam in a direction perpendicular to its incident direction. Each of the quarter-wave plates 7a and 7b converts a linearly polarized light beam to a circularly polarized light bear, and vice versa. each of the corner cube prisms 8a and 8b reflects an incident light beam in a direction parallel to its incident direction. The optical receiver or detector 9 detects the intensity of an incident light beam or beams.

The laser source 3, the beam splitter 4, the quarter-wave places 7a and 7b, the mirror 1, and the detector 9 are mounted on the top surface 30a of a table 30 fixed to a specific position. On the other hand, the corner cube prisms 8a and 8b are attached on the surface 20a of an object 20 movable in the direction denoted by M by way of supporting members 15a and 15b, respectively. The surface 20a of the object 20 is a target surface to be measured. The object 20 is movable along an axis with respect to the fixed table 30. The object 20 is apart from the table 30 in the direction by a specific distance. The side face 30b of the table 30 is opposite to the surface 20a of the object 20.

Here, the Z and X axes are defined on the top surface 30a of the table 30, as shown in FIG. 6. The Z axis is parallel to the M direction. The X axis is perpendicular to the Z axis.

The laser source 3 is mounted on the top surface 30a of the table 30 at the specific location in such a way that the beam emission direction is perpendicular to the target surface 20a of the object 20. The source 3 emits an initial laser beam L0 containing the vertically polarized component and the horizontally polarized component toward the surface 20a. The initial beam L0 travels along the Z axis. The surface 20a is parallel to the X axis.

The beam splitter 4 is apart from the laser source 3 and aligned to the same along the Z axis. The splitter 4 is located on the optical path of the initial beam L0 along the Z axis. The splitter 4 allows the horizontally polarized component of the initial beam L0 to pass through the splitter 4 in the +Z direction toward the object 20 without changing its direction. At the same time, the splitter 4 reflects the vertically polarized component of the initial beam L0 and turns it to the +X direction toward the mirror 5. Thus, the splitter 4 splits the initial beam L0 into a sub-beam L1 traveling in the +Z direction from the horizontally polarized component of the initial beam. L0 and a sub-beam L2 traveling in the +X direction from the vertically polarized component of the initial beam L0.

Moreover, the beam splitter 4 reflects a reflected sub-beam L1′ traveling in the −Z direction by the corner cube prism 9a to the −X direction toward the detector 9. At the same time, the splitter 4 allows a reflected sub-beam L2′ traveling in the −X direction, which has been reflected by the corner cube prism 8b and the mirror 5, to pass through the same without changing its direction toward the detector 9.

The quarter-wave plate 7a is located near the splitter 4 and aligned to the same along the Z axis. The plate 7a is located on the optical path of the sub-beam L1 emitted from the splitter 4 along the Z axis. The plate 7a converts the linearly polarized sub-beam L1 to a circularly polarized one. Also, the plate 7a converts the circularly polarized, reflected sub-beam L1′ by the prism 8a to a linearly polarized one.

The quarter-wave plate 7b is located near the splitter 4 and aligned to the same along the X axis. The plate 7b is located on the optical path of the sub-beam L2 emitted from the splitter 4 along the X axis. The plate 7b converts the linearly polarized sub-beam L2 to a circularly polarized one. Also, the plate 7b converts the circularly polarized, reflected sub-beam L2′ by the prism 6b to a linearly polarized one.

The quarter-wave plates 7a and 7b have the following function. Specifically, if an optical beam pass through the quarter-wave plate 7a or 7b twice, the plane of polarization of the beam is turned by 90°. Thus, if an incident beam is a horizontally polarized beam, it is converted to a vertically polarized one. If an incident beam is a vertically polarized beam, it is converted to a horizontally polarized one.

The mirror 5 is located near the quarter-wave plate 7a and aligned to the same along the X axis. The mirror 5 is located on the optical path of the sub-beam L2 emitted from the splitter 4 along the X axis. The reflecting plane of the mirror 5 is tilted at an angle of 45°with respect to the Z axis. The mirror 5 reflects the sub-beam L2 from the splitter 4 and turns it to the +Z direction toward the prism 8b. Also, the mirror 5 reflects the reflected sub-beam L2′ by the prism 5b and turns it to the −X direction toward the splitter 4.

The corner cube prism 8a has a pair of reflection planes 13a and 14a perpendicular to each other. Each of the planes 13a and 14a is at an angle of 45°with respect to the Z axis. The plane 13a is located on the optical path of the sub-beam L1 emitted from the splitter 4. The prism 8a reflects the sub-beam L1 and turns it to the −Z direction with the planes 13a and 14a. Also, the prism 8a reflects the reflected sub-beam L1′ by the mirror 1 and turns it to the −Z direction with the planes 13a and 14a.

The corner cube prism 8b, which is aligned with the prism 8a along the X axis on the surface 20a of the object 20, is apart from the prism 8a at a specific distance d. The prism 8b has a pair of reflection planes 13b and 14b perpendicular to each other. Each of the planes 13b and 14b is at an angle of 45°with respect to the Z axis. The plane 13b is located on the optical path of the sub-beam L2 reflected by the mirror 5 and traveling in the +Z direction. The prism 8b reflects the sub-beam L2 and turns it to the −Z direction with the planes 13b and 14b. Also, the prism 8b reflects the reflected sub-beam L2′ by the mirror 1 and turns it to the −Z direction with the planes 13b and 14b.

The mirror 1 is located on the top surface 30a of the table 30 in the vicinity of its side face 30b while the mirror or reflection plane of the mirror 1 faces the surface 20a of the object 20. The reflection plane of the mirror 1 is perpendicular to the Z axis. The mirror 1 has an aperture 2a located on the optical path of the sub-beam L1 emitted from the splitter 4 and an aperture 2b located on the optical path of the sub-beam L2 reflected by the mirror 5. The apertures 2a and 2b have sizes that allow the sub-beams L1 and L2 to pass through, respectively. The mirror 1 reflects the sub-beams L1 and L2 reflected by the corner cube prisms 8a and 8b and turns them to the Z direction, respectively, forming the reflected sub-beams L1′ and L2′.

The optical detector 9 is located near the beam splitter 4 in such a way that the reception surface of the detector 9 faces the beam splitter 4a. The reception surface of the detector 9 is located on the optical paths of the refleoted sub-beams L1′ and L2′ emitted from the splitter 4a. The detector 3 detects or measures the intensity of the sub-beams L1′ and L2′.

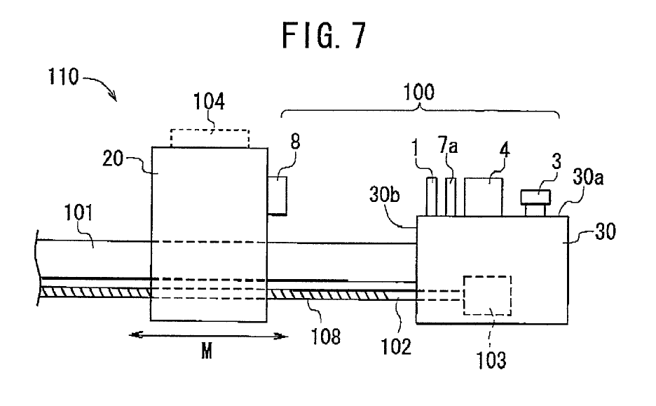

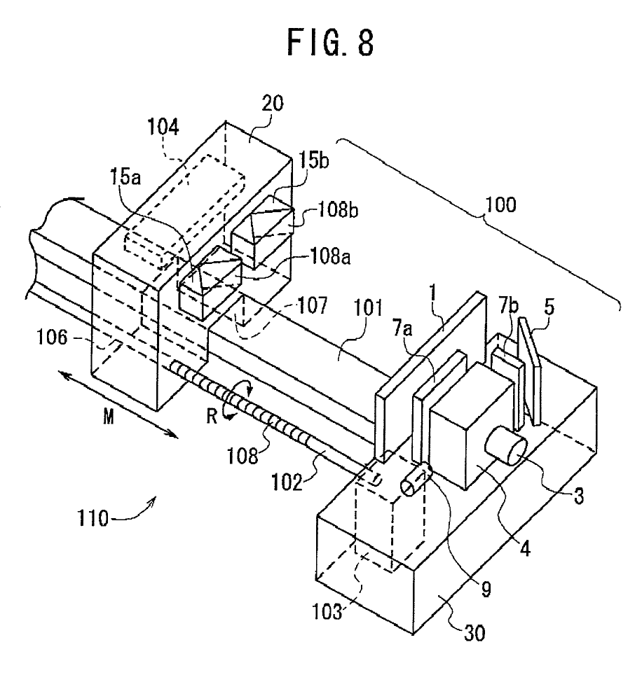

The laser measuring device 100 having the above-described configuration is, for example, applied to a single axis stage mechanism 110 shown in FIGS. 7 and 8.

With the single axis stage mechanism 110, a rail 101 is fixed to the fixed table 30. A motor 103 is mounted in the table 30. A driving shaft 102 with a thread 108 is held parallel to the rail 101. An end of the shaft 102 is connected to the rotation shaft of the motor 103. The object 20 to be measured is a movable stage with a gap 107 at the bottom. The gap 107 is engaged with the rail 101, holding the object or stage 20 slidably on the rail 101. The object 20 has a penetrating, threaded hole 106 meshing with the thread 108 of the shaft 102.

The driving shaft 102 is rotated along the arrow R by the rotation of the motor 103, thereby moving the object or stage 20 in the direction denoted by the arrow M parallel to the shaft 102. Thus, the stage 20 is displaced toward or from the table 30 along the shaft 102.

For example, if the single axis stage mechanism is designed for a lathe, a workpiece 104 is placed on the object or stage 20, as shown in FIGS. 7 and 8.

Next, the operation of the laser measuring device 100 is explained below.

The initial laser beam L0 emitted from the laser source 3 enters the polarized beam splitter 4, thereby forming the laser sub-beam L1 traveling in the +Z direction and the laser sub-beam L2 traveling in the +X direction.

The laser sub-beam L1 emitted from the splitter 4 passes through the quarter-wave plate 7a and the aperture 2a of the mirror 1 to enter the corner cube prism 8a on the object 20. The linearly polarized sub-beam L1 is converted to the circularly polarized one by the plate 74.

In the prism 8a, the sub-beam L1 is reflected twice by the reflecting planes 13a and 14a and is turned to the −Z direction (i.e., the opposite direction to the incident one). At this time, the sub-beam L1 is shifted in the +X direction and thus, the sub-beam L1 travels in the −Z direction to reach the mirror 1 on the table 30. Since the sub-beam L1 is perpendicular to the reflecting plane of the mirror 1, the sub-beam L1 is reflected in the +Z direction by the mirror 1, forming the reflected sub-beam L1′ traveling in the opposite direction to the incident sub-beam L1 on the same optical path. The reflected sub-beam L1′ enters the prism 8a.

In the prism 8a, the reflected sub-beam L1′ is reflected mwice by the reflecting planes 14a and 13a and is turned to the −Z direction (i.e., the opposite direction to the sub-beam L1). At this time, the sub-beam L1′ is shifted in the −X direction and thus, the sub-beam L1′ travels in the −Z direction toward the table 30. The sub-beam L1′ passes through the aperture 2a of the mirror 1 and the quarter-wave plate 7a to enter the beam splitter 4 on the table 30. The circularly polarized sub-beam L1′ is converted to the linearly polarized one by the plate 7a. This means that the sub-beam L1′ enters the splitter 4 as the vertically polarized beam. Thus, the sub-beam L1′ is reflected by the splitter 4 and turned to the −X direction, entering the optical detector.

As explained above, the laser sub-beam L1 formed by the splitter 4 forms the optical path OP1 from the splitter 4 to the mirror 1 by way of the corner cube prism 8a. The reflected sub-beam L1′ formed by the mirror 1 travels on the same path OP1 in the opposite direction. Thus, it can be said that the incident sub-beam L1 makes a round trip along the path OP1. The intensity of the reflected sub-beam L1′ thus returned to the splitter 4 is then detected or measured by the detector 9.

On the other hand, the incident laser sub-beam L2 emitted from the splitter 4 passes through the quarter-wave plate 7b and then, it is reflected by the mirror 5. Thereafter, the sub-beam L2 passes through the aperture 2b of the mirror 1 to enter the corner cube prism 8b on the object 20. The linearly polarized sub-beam 12 is converted to the circularly polarized one by the plate 7b.

In the prism 8b, the sub-beam L2 is reflected twice by the reflecting planes 13b and 14b and is turned to the −Z direction (i.e., the opposite direction to the incident one). At this time, the sub-beam L2 is shifted in the +X direction and thus, the sub-beam L2 travels in the −Z direction to reach the mirror 1 on the table 30. Since the sub-beam L2 is perpendicular to the reflecting plane of the mirror 1, the sub-beam L2 is reflected in the +Z direction by the mirror l, forming the reflected sub-beam L2′ traveling in the opposite direction to the incident sub-beam L2 on the same optical path. The reflected sub-beam L2′ enters the prism 8b.

In the prism 8b, the reflected sub-beam L1′ is reflected twice by the reflecting planes 14b and 13b and is turned to the −Z direction (i.e., the opposite direction to the sub-beam L2). At this time, the sub-beam L2′ is shifted in the −X direction and thus, the sub-beam L2′ travels in the −Z direction toward the table 30. The sub-beam L2′ passes through the aperture 2b of the mirror 1 and the quarter-wave plate 7b to enter the beam splilter 4 on the table 30. The circularly polarized sub-beam L2′ is converted to the linearly polarized one by the plate 7b. This means that the sub-beam L2′ enters the splitter 4 as the horizontally polarized beam. Thus, the sub-beam L2′ passes through the splitter 4 without changing its direction, entering the optical detector 9.

As explained above, the laser sub-beam L2 formed by the splitter 4 forms the optical path OP2 from the splitter 4 to the mirror 1 by way of the corner cube prism 8b. The reflected sub-beam L2′ formed by the mirror 1 travels on the same path OP2 in the opposite direction. Thus, it can be said that the sub-beam L2 makes a round trip along the path OP2. The intensity of the reflected sub-beam L2′ thus returned to the splitter 4 is detected or measured by the detector 9.

The sum of the optical paths of the incident sub-beam L1 and the reflected sub-beam L1′ (which is defined as the first overall optical path) is different from the sum of the optical paths of the incident sub-beam L2 and the reflected sub-beam L2′ (which is defined as the second overall optical path). Thus, optical interference occurs between the reflected sub-beams L1′ and L2′, causing some change or fluctuation of the intensity of the interference beam. The intensity of the interference beam varies according to the difference between the first and second overall optical paths.

If yawing of the object 20 occurs during the moving operation of the object 20 in the M direction, the difference between the optical path lengths of the sub-beams L1 and L2 increases, changing the intensity of the interference team at the detector 9. As a result, the yawing angle of the object 20 with respect to the table 30 can be measured using a known method.

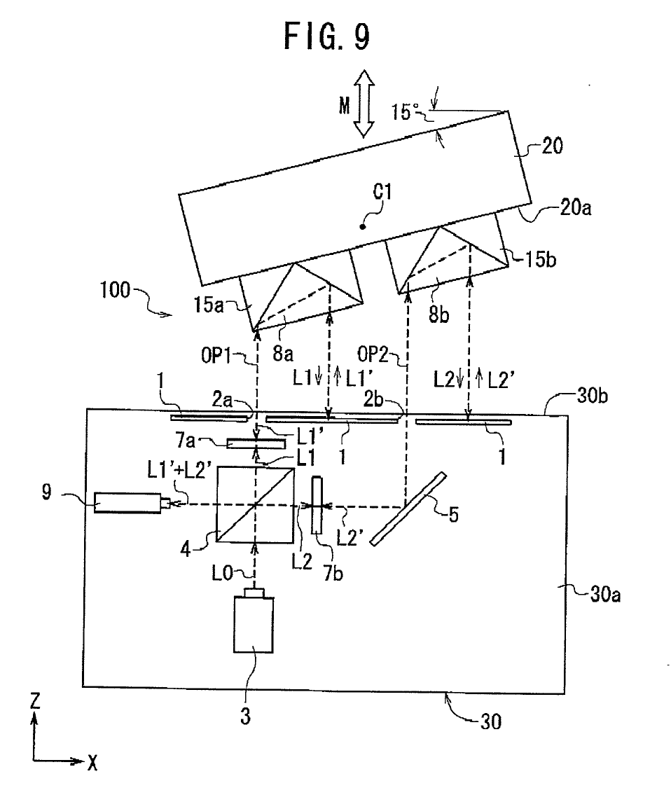

When the object 20 is displaced with yawing, the corner cube prisms 8a and 8b are tilted with the object 20. Thus, as seen from FIG. 9, the sub-beams L1 and L2 are reflected by the reflecting planes 13a and 14a and 13b and 14b of the prisms 8a and 8b at the shifted points in the −X direction compared with the case where no yawing occurs.

However, with the laser measuring device 100 according to the first embodiment, the resultant sub-beams L1 ′ and L2′ emitted from the prisms 8a and 8b travel in the −Z direction to enter the mirror 1. This means that the incoming sub-beams L1 and L2 are reflected by the mirror 1 to the +Z direction in the same way as the case where no yawing occurs, forming the reflected sub-beams L1′ and L2′ traveling in the +Z direction on the optical paths OP1 and OP2 to the prisms 8a and 8b, respectively.

As a result, the shift or change of the reflected laser sub-beams L1′ and L2′ traveling toward the optical detector 9 can be eliminated or suppressed even if yawing (as one of the displacement errors) of the object 20 exists.

For example, as shown in FIG. 9, even if specific yawing of the object 20 occurs around the axis C1 on the object 20 at a large yawing angle of 15°counterclockwise, the reflected sub-beams L1′ and L2′ can be surely received by the detector 9. This means that the measurement is possible even in such the case. If the yawing angle increases further (e.g., approximately 30°to 40′), the measurement is possible as well.

Since the positional adjustment of the optical detector required in the prior-art laser measuring device 200 is unnecessary, the measurement time is reduced.

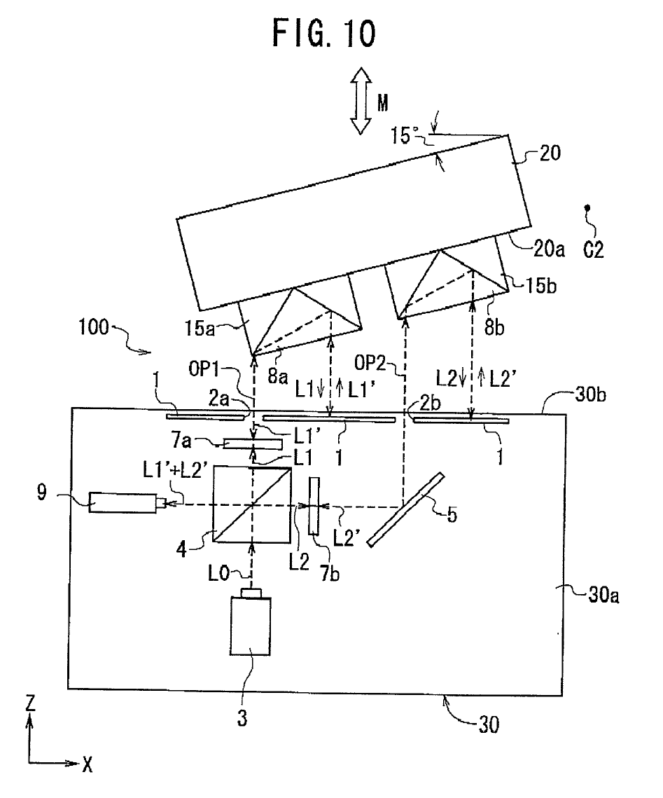

As shown in FIG. 10, even if specific yawing of the object 20 occurs around the axis C2 outside the object 20 at a large yawing angle of 15°counterclockwise, the reflected sub-beams L1′ and L2′ are substantially the same as the case where no yawing occurs. Thus, the measurement is possible even in such the case. Since the positional readjustment of the corner cube prisms required in the prior-art laser measuring device 200 is unnecessary, the measurement time is reduced. Also, no additional place is necessary for attaching the corner cube prisms and thus, the measurement accuracy degradation does not occur due to the additional plate.

Moreover, the sub-beam L1 makes a round trip along the optical path OP1 between the beam splitter 4 and the mirror 1 by way of the corner cube prism 8a. The sub-beam L2 makes a round trip along the optical path OP2 between the beam splitter 4 and the mirror 1 by way of the corner cube prism 8b. Accordingly, the difference between the lengths of the optical paths OP1 and OP2 is twice as much as the prior-art laser measuring device 200. As a result, resolving power in measurement is enhanced.

Since the positional shift of the sub-beams L1′ and L2′ wizh respect no the detector 9 is substantially zero in spite of yawing, the distance d between the corner cube prisms 8a and 8b can be increased as desired. This enhances the resolving power in measurement as well.

As seen frqm above explanation with reference to FIGS. 6 to 10, the laser measuring device 100 according to the first embodiment is simple in configuration and therefore, the device 100 has an additional advantage that it is light-weight, compact, and low-cost.

### SECOND EMBODIMENT

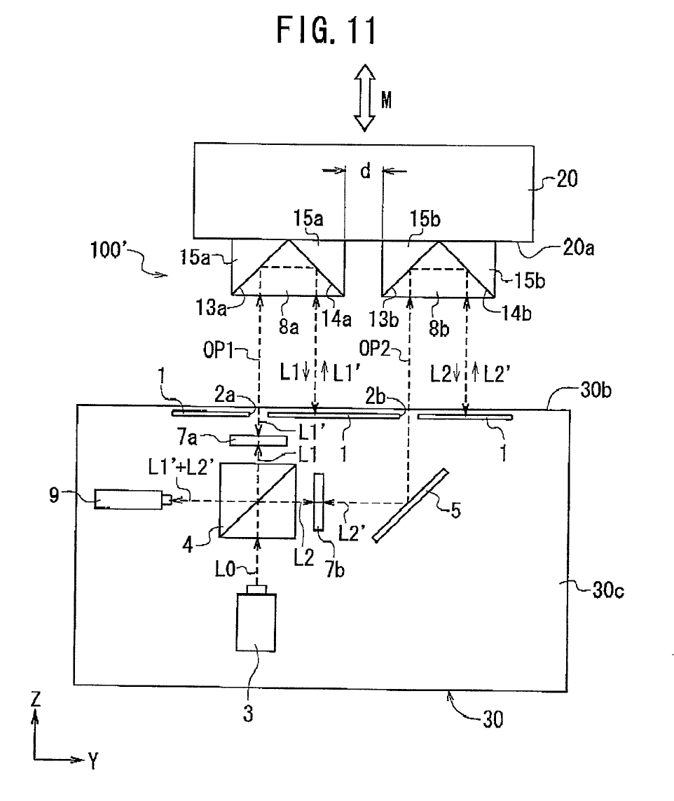

A laser measuring device according to a second embodiment of the invention has a configuration as shown in FIG. 11.

As seen from FIG. 11, the laser measuring device 100′ according to the second embodiment is substantially the same in configuration as the laser measuring device according to the first embodiment of FIG. 6, except that rhe elements or parts mounted on the top surface 30a of the table 30 in the laser measuring device according to the first embodiment are rotated around an axis perpendicular to the target surface 20a of the object 20. This is to measure the pitching angle of the object 20, instead of the yawing angle thereof. Therefore, the explanation about the same configuration is omitted here for the sake of simplification by attaching the same reference symbols as used in the first embodiment to the same elements in FIG. 11.

In the laser measuring device 100′ according to the second embodiment, the laser source 3, the polarized beam splitter 4, the quarter-wave plates 7a and 7b, the mirrors 5 and 1, and the optical detector 9 are mounted on the side face 30c of the table 30. The prisms 8a and 8b are attached to the surface 20a of the object 20 and arranged along the Y axis perpendicular to the X and Z axes, as shown in FIG. 11.

The pitching angle of the object 20, which is caused by the rotation of the surface 20a around an axis parallel to the X axis, can be measured by the device 100′.

Even if pitching (as one of the displacement errors) of the object 20 occurs, the shift or change of the reflected laser sub-beams L1′ and L2′ traveling toward the optical detector 9 can be eliminated or suppressed because of the same reason as explained in the first embodiment. Thus, the positional shift of the sub-beams L1′ and L2′ with respect to the detector 9 is substantially zero in spire of pitching. As a result, there are the same advantages as those in the first embodiment.

### THIRD EMBODIMENT

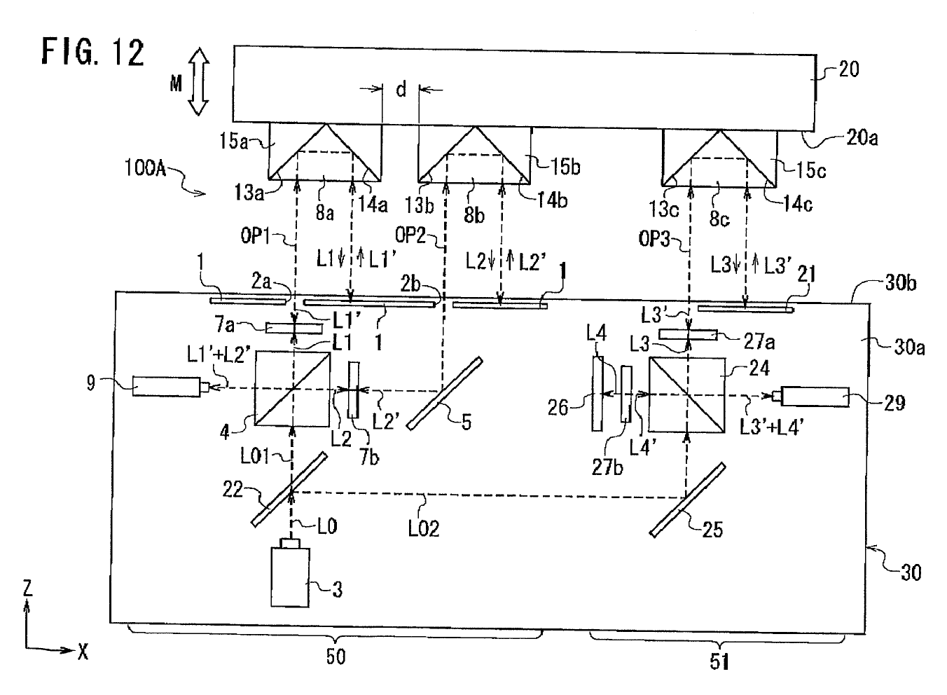

FIG. 12 shows a laser measuring device 100A according to a third embodiment ot the invention, which comprises a displacement error measuring section 50 for measuring the yawing angle of the object 20 and a displacement measuring section 51 for measuring the displacement (i.e.r moving distance) of the object 20.

The displacement error measuring section 50 is the same in configuration as the laser measuring device 100 according to the first embodiment of FIG. 6, except that a half mirror 22 is additionally provided to form two laser beams L01 and L02 from the initial laser beam L0 emitted from the laser source 3. Therefore, the explanation about the same configuration is omitted here for the sake of simplification by attaching the same reference symbols as used in the first embodiment to the same elements in FIG. 12.

The half mirror 22 is located on the top surface 30a of the table 30 between the laser source 3 and the polarized beam splitter 4. The mirror 22 is on the optical path of the initial laser beam L0 traveling in the +Z direction. The mirror 22 allows a half of the beam L0 to pass through the same and reflects the remainder of the beam L0 to the +Z direction, forming the laser beam L01 traveling in the +Z direction and the laser beam L02 traveling in the +X direction.

The displacement measuring section 51 comprises a mirror 25, a polarized beam splitter 24, two quarter-wave plates 27a and 27b, two mirrors 21 and 26, an optical detector 29, and a corner cube prism 8c. The mirror 25, the splitter 24, the plates 27a and 27b, the mirrors 21 and 26, and the detector 29 are mounted on the top surface 30a of the fixed table 30. The prism 8c is attached to the target surface 20a of the object 20 by way of a supporting member 15c.

The mirror 25 is located on the optical path of the laser beam L02 emitted from the half mirror 22. The mirror surface or reflecting surface of the mirror 25 is tilted by 45°with respect to the Z axis. The mirror 25 reflects the beam L02 traveling in the +X direction and turns it to the +Z direction.

The beam splitter 24 is apart from the mirror 25 and aligned to the same along the Z axis. The splitter 24 is located on the optical path of the beam L02 alongthe Z axis. The splitter 24 allows the horizontally polarized component of the beam L02 to pass through the same in the 42 direction toward the object 20 without changing its direction. At the same time, the splitter 24 reflects the vertically polarized component of the beam L02 and turns it to the −X direction toward the mirror 26. Thus, the splitter 24 splits the beam L02 into a sub-beam L3 traveling in the +Z direction from the horizontally polarized component of the beam L02 and a sub-beam L4 traveling in the −X direction from the vertically polarized component of the beam L02.

Moreover, the splitter 24 reflects a reflected sub-bear L3′ traveling in the direction, which has been reflected by the corner cube prism 8c, and turns the sub-beam L3′ to the +X direction toward the detector 29. At the same time, the splitter 24 allows a reflected sub-beam L4′ traveling in the +Z direction by the mirror 26 to pass through the same without changing its direction toward the detector 29.

The quarter-wave plate 27a is located near the splitter 24 and aligned no the same along the Z axis. The plate 27a is located on the optical path of the sub-beam L3 emitted from the splitter 24 along the Z axis. The plate 27a converts the linearly polarized sub-beam L3 to a circularly polarized one. Also, the plate 27a converts the circularly polarized, reflected sub-beam L3′ by the prism 8c to a linearly polarized one.

The quarter-wave plate 27b is located near the splitter 24 and aligned to the same along the X axis. the place 27b is located on the optical path of the sub-beam L4 emitted from the splitter 24 along the X axis. The place 27b converts the linearly polarized sub-beam L4 emitted from the splitter 24 to a circularly polarized one. Also, the plate 27b converts the circularly polarized, reflected sub-beam L4′ by the mirror 26 to a linearly polarized one.

The mirror 26 is located near the quarter-wave plate 27b and aligned to the same along the X axis. The mirror 26 is located on the optical path of the sub-beam L4 emitted from the splitter 24 along the X axis. The flat reflecting plane of the mirror 26 is parallel to the Z axis. Thus, the mirror 26 reflects the sub-beam L4 traveling in the −X direction from the splitter 24 and turns it to the +X direction toward the detector 29, forming the reflected sub-beam L4′.

The corner cube prism 8c has a pair of reflection planes 13c and 14c perpendicular to each other. Each of the planes 13c and 14c is at an angle of 45°with respect to the Z axis. The plant 13c is located on the optical path of the sub-beam L3 emitted from the splitter 24. The plane 14c, which is opposite to the mirror 21 on the table 30, is located on the optical path of the sub-beam L3′ reflected by the mirror 21. The prism 8c reflects the sub-beam L3 traveling in the +Z direction and turns it to the −Z direction with the planes 13c and 14c. Also, the prism 8c reflects the reflected sub-beam L3′ traveling in the +Z direction and turns it to the −Z direction with the planes 13c and 14c.

The mirror 21 is located on the top surface 30a of the table 30 in the vicinity of its side face 30b while the flat mirror or reflecting plane of the mirror 21 faces the target surface 20a of the object 20. The flat reflecting plans of the mirror 21 is perpendicular to the Z axis. The mirror 21 is located not to interrupt the sub-beams L3 and L3′. The mirror 21 reflects the sub-beam L3 traveling in the −Z direction reflected by the corner cube prism 8c, and turns it to the +Z direction, forming the reflected sub-beam L3′.

The optical detector 29 is located near the beam splitter 24 in such a way that the reception surface of the detector 29 faces the beam splitter 24. The reception surface of the detector 29 is located on the optical paths of the reflected sub-beams L3′ and L4′ emitted from the splitter 24. The detector 29 detects or measures the intensity of the sub-beams L3′ and L4′.

Next, the operation of the laser measuring device 100A according to the third embodiment is explained below.

The initial laser beam L0 emitted from the laser source 3 enters the half mirror 22, forming the laser beams L01 and L02. The beam L01 enters the beam splitter 4 to be split into the two sub-beams L1 and L2.

In the displacement error measuring section 50, the yawing angle is measured using the sub-beams L1 and L2 in the same way as explained in the laser measuring device 100 according to the first embodiment. Therefore, no further explanation on this is omitted here.

In the displacement measuring section 51, the laser beam L02 formed by the half mirror 22 is used.

Specifically, the beam L02 traveling in the +X direction from the splitter half mirror 22 is reflected by the mirror 25 and the, it is turned to the +Z direction, entering the polarized beam splitter 24. In the splitter 24, the beam L02 is divided into the sub-beam L3 traveling in the +Z direction toward the object 20 and the sub-beam L4 traveling in the −X direction toward the mirror 26.

The sub-beam L3 thus formed travels in the +Z direction to pass through the quarter-wave plate 27a, entering the corner cube prism 8c on the object 20. The linearly polarized sub-beam L3 is converted to the circularly polarized one by the plate 27a.

In the prism 8c, the sub-beam L3 is reflected twice by the reflecting planes 13c and 14c and is turned to the −Z direction (i.e., the opposite direction to the incident one). At this time, the sub-beam L3 is shifted in the +X direction and thus, the sub-beam L3 travels in the −Z direction to reach the mirror 21 on the table 30. Since the sub-beam L3 is perpendicular to the reflecting plane of the mirror 21, the sub-beam L3 is reflected in the +Z direction by the mirror 21, forming the reflected sub-beam L3′ traveling in the opposite direction to the incident sub-beam L3 on the same optical path. The reflected sub-beam L3′ enters the prism 8c.

In the prism 5c, the reflected sub-beam L3′ is reflected twice by the reflecting planes 14c and 13c and is turned to the −Z direction (i.e., the opposite direction to the sub-beam L3). At this time, the sub-beam L3′ is shifted in the −X direction and thus, the sub-beam L3′ travels in the −Z direction toward the table 30. The sub-beam L3′ passes through the quarter-wave plate 27a to enter the beam splitter 24 on the table 30. The circularly polarized sub-beam L3′ is converted to the linearly polarized one by the plate 27a. This means that the sub-beam L3′ enters the splitter 24 as the vertically polarized beam. Thus, the sub-beam L3′ is turned to the +X direction by the splitter 24, entering the optical detector 29.

As explained above, the laser sub-beam L3 formed by the splitter 24 forms the optical path OP3 from the splitter 24 to the mirror 21 by way of the corner cube prism 8c. The reflected sub-beam L3′ formed by the mirror 21 travels on the same path OP3 in the opposite direction. Thus, it can be said that the sub-beam L3 makes a round trip alqng the path OP3. The intensity of the reflected sub-beam L3′ thus returned is detected or measured by the detector 29.

On the other hand, the sub-beam L4 emitted from the splitter 24 travels in the −X direction to pass through the quarter-wave plate 27b, reaching the mirror 26. The linearly polarized sub-beam L4 is converted to the circularly polarized one by the plate 27b.

The sub-beam L3 is then reflected by the flat reflecting plane of the mirror 26 and is turned to the +X direction (i.e., the opposite direction to the incident one), forming the reflected sub-beam L4′ traveling in the opposite direction to the incident sub-beam L4 on the same optical path.

The reflected sub-beam L4′ thus formed pass through the quarter-wave plate 27b, entering the splitter 24. The circularly polarized sub-beam L4′ is converted to the linearly polarized one by the plate 27b. This means thai the sub-beam L4′ enters the splitter 24 as the horizontally polarized beam. Thus, the sub-beam L4′ pass through the splitter 24 without direction change to enter the optical detector 29.

The displacement (i.e., moving distance) of the object 20 is measured by detecting the intensity of the interference beam formed by the sub-beams L3′ and L4′. Specifically, if some displacement of the object 20 occurs, the sum of the optical path lengths of the sub-beams L3 and L3′ varies. On the other hand, the sum of the optical path lengths of the sub-beams L4 and L4′ is kept constant. Thus, the intensity of the interference beam changes according to the displacement of the object 20. As a result, using a known method, the displacement of the object 20 can be measured on the basis of the intensity change of the interference beam.

Also, the velocity (i.e., the moving rate) of the object 20 can be measured by differentiating its displacement by time.

When the object 20 is displaced with yawing or pitching, the corner cube prism 8c is tilted with the object 20. Thus, the sub-beam L3 is reflected by the reflecting planes 13c and 14c at the shifted points along the X axis in the prism 8c compared with the case where no yawing or pitching occurs.

However, with the laser measuring device 100A according to the third embodiment, the resultant sub-beam L3 emitted from the prism 8c travels in the −Z direction to enter the mirror 21. This means that the resultant sub-beam L3 from the prism 8c, is reflected by the mirror 21 to the +Z direction in the same way as the case where no yawing nor pitching occurs, forming the reflected sub-beam L3′ traveling in the +Z direction on the optical path OP3 to the prism 5c.

As a result, the shift or change of the reflected laser sub-beam L3′ traveling toward the beam splitter 24 can be eliminated or suppressed even if yawing or pitching (as one of rhe displacement errors) of the object 20 exists.

Accordingly, like the laser measuring device 100 according to the first embodiment, even if specific yawing or pitching of the object 20 occurs at a large yawing or pitching angle, the measurement is possible.

Since the positional adjustment of the optical detector and the positional readjustment of the corner cube prisms required in the prior-art laser measuring device 200 is unnecessary, the measurement time is reduced. Also, the additional plate required in the prior-art laser measuring device 200 does not needed and thus, the measurement accuracy degradation does not occur due to the additional plate.

Moreover, the sub-beam L3 makes a round trip along the optical path OP3 between the beam splitter 24 and the mirror 21 by way of the corner cube prism. Accordingly, the total length change of the sum of the optical paths of the sub-beams L3 and L3′ is twice as much as the prior-art laser measuring device 200. As a result, resolving power in measurement is enhanced.

### FOURTH EMBODIMENT

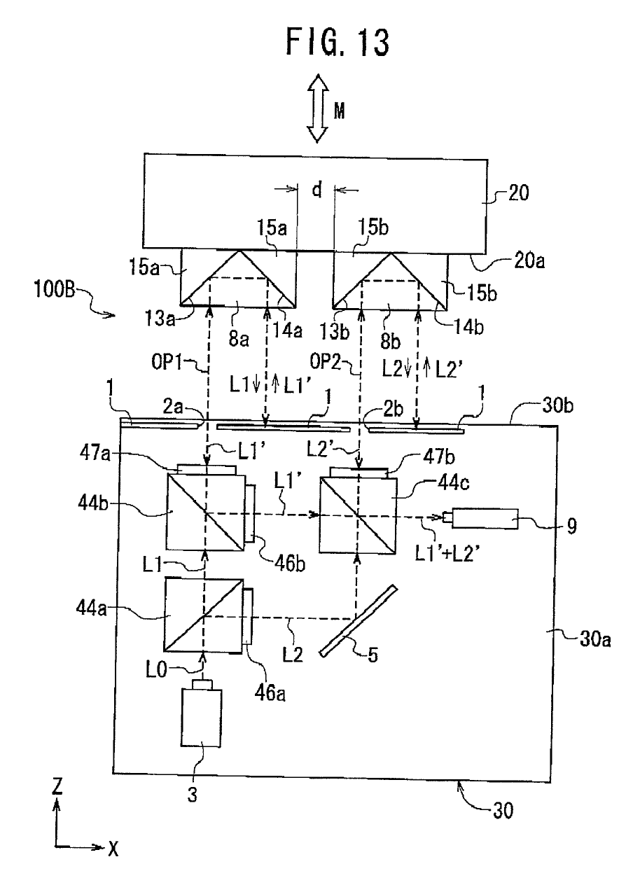

FIG. 13 shows a laser measuring device 100B according to a fourth embodiment of the invention.

As shown in FIG. 13, the laser measuring devise 100B according to the fourth embodiment comprises a laser source 3, three polarized beam splitters 44a, 44b, and 44c, a mirror 5, two half-wave plates 46a and 46b, two quarter-wave plates 47a and 47b, a mirror 1, two corner cube prisms 8a and 8b, and an optical detector or receiver 9.

The laser source 3, the beam splitters 44a, 44b, and 44c, the mirror 5, the half-wave plates 46a and 46b, the quarter-wave plates 47a and 47b, the mirror 1, and the detector 9 are mounted on the top surface 30a of the fixed table 30. The corner cube prisms 8a and 8b are attached to the target surface 20a of the object 20 by way of supporting members 15a and 15b, respectively. The side face 30b of the table 30 is opposite to the surface 20a of the object 20.

Here, the Z and X axes are defined on the top surface 30a of the table 30, as shown in FIG. 13, in which the X axis is perpendicular to the Z exit.

The laser source 3 is mounted on the surface 30a of the table 30 at the specific location in such a way that the beam emission direction is perpendicular to the surface 20a of the object 20. The source 3 emits an initial laser beam L0 containing the vertically polarized component and the horizontally polarized component toward the surface 20a. The initial beam L0 travels along the Z-axis. The surface 20a is parallel to the X axis.

The polarized beam splitter 44a is apart from the laser source 3 and aligned to the same along the Z axis. The splitter 44a is located on the optical path of the initial beam L0 along the Z axis. The splitter 44a allows the horizontally polarized component of the initial beam L0 to pass through the splitter 44a in the +X direction toward the object 20 without changing its direction. At the same time, the splitter 44a reflects the Vertically polarized component of the initial beam L0 and turns it to the +X direction toward the mirror 5. Thus, the splitter 44a splits the initial beam L0 into a sub-beam L1 traveling in the +Z direction from the horizontally polarized component of the beam L0 and a sub-beam L2 traveling in the +X direction from the vertically polarized component of the beam L0.

The half-wave plate 46a is located near the splitter 44a and aligned to the same along the X axis. The plate 46a is located on the optical path of the sub-beam L2 emitted from the splitter 44a along the X axis. The plate 46a roatates the plane of polarization of the sub-beam L2 by 90°, thereby converting the vertically polarized sub-beam L2 to a horizontally polarized one.

The polarized beam splitter 44b is apart from the beam splitter 44a and aligned to the dame along the Z axis. The splitter 44b is located on the optical path of the sub-beam L1 along the Z axis. The splitter 44b allows the sub-beam L1 to pass through the same in the +Z direction toward the object 20 without changing its direction. At the same time, the splitter 44b reflects the reflected sub-beam L1′ by the corner cube prism 8a and turns it to the +X direction toward the splitter 44c.

The half-wave plate 48b is locazed near the splitter 44b and aligned to the same along rhe X axis. The plate 46b is located on the optical path of the reflected sub-beam L1′ emitted from the splatter 44b along the X axis. The plate 46b rotates the plane of polarization of the sub-beam L1′ by 90°, thereby converting the vertically polarized sub-beam L1′ to a horizontally polarized one.

The mirror 5 is located near the half-wave plate 46a and aligned to the same along the X axis. The mirror 5 is located on the optical path of the sub-beam L2 emitted from the splitter 44a along the X axis. The reflecting plane of the mirror 5 is tilted at an anglo of 45°with respect to the Z axis. The mirror 5 reflects the sub-beam L2 and turns it to the +Z direction toward the beam splitter 44c.

The polarized beam splitter 44c is apart from the beam splitter 44b and aligned to the same along the X axis. The splitter 44c is located at the intersection between the optical path of the sub-beam L2 along the Z axis and the optical path of the sub-beam L1′ emitted by the splitter 44b along the X axis. The splitter 44c allows the sub-beam L2 to pass through the same in the +Z direction toward the object 20 without changing its direction while it allows the sub-beam L1′ to pass through the same in the +X direction toward the detector 9 without changing its direction. At the same rime, the splitter 44c reflects the reflected sub-beam L2′ by the corner cube prism 8b on the object 20 and turns it from the −Z direction to the +X direction toward the detector 9.

The quarter-wave plate 47a is located near the splitter 44b and aligned to the sarfte along the Z axis The plate 47a is located on the optical path of the sub-beam L1 emitted from the splitter 44a along the Z axis. The plate 47a converts the linearly polarized sub-beam L1 to a circularly polarized one. Also, the plate 47a converts the circularly polarized, reflected sub-beam L1′ by the prism 8a to a linearly polarized one.

The quarter-wave plate 47b is located near the splitter 44c and aligned to the same along the Z axis. The plate 47b is located on the optical path of the sub-beam L2 reflected by the mirror 5 along the Z axis. The plate 47b converts the linearly polarized sub-beam L2 to a circularly polarized one. Also, the plate 47b converts the circularly polarized, reflected sub-beam L2′ by the prism 8b to a linearly polarized one.

The corner cube prism 8a has a pair of reflection planes 13a and 14a perpendicular to each other. Each of the planes 13a and 14a is at an angle of 45°with respect to the Z axis. The plane 13a is located on the optical path of the sub-beam L1 emitted from the splitter 44b. The plane 14a is opposite to the mirror 1. The prism 8a reflects the sub-beam L1 and turns it from the +Z direction to the −Z direction with the planes 13a and 14a. Also, the prism 8a reflects the reflected sub-beam L1′ by the mirror 1 and turns it from the +Z direction to the −Z direction with the planes 13a and 14a.

The corner tube prism 8b, which is aligned with the prism 8a along the X axis on the surface 20a of the object 20, is apart from the prism 8a at a specific distance d. The prism 8b has a pair of reflection planes 13b and 14b perpendicular to each other. Each of the planes 13b and 14b is at an angle of 45°with respect to the Z axis. The plane 13b is located on the optical path of the sub-beam L2 emitted by the splitter 44c and traveling in the +Z direction. The plane 14b is opposite to the mirror 1. The prism 8b reflects the sub-beam L2 and turns it from the +Z direction to the −Z direction with the planes 13b and 14b. Also, the prism 8b reflects the reflected sub-beam L2′ by the mirror 1 and turns it from the +Z direction to the −Z direction with the planes 13b and 14b.

The mirror 1 is located on the top surface 30a of the table 30 in the vicinity of its side face 30b while the frat mirror or reflecting plane of the mirror 1 faces the surface 20a of the object 20. The reflecting plane of the mirror 1 is perpendicular to the Z axis. The mirror 1 has an aperture 2a located on the optical path of the sub-beam L1 emitted from the splinter 44b and an aperture 2b located on the optical path of the sub-beam L2 emitted from the splitter 44c. The apertures 2a and 2b have sizes that allow the sub-beams L1 and L2 to pass through, respectively. The mirror 1 reflects the incoming sub-beams L1 and L2 reflected by the corner cube prisms 8a and 8b and turns them from the −Z direction to the +Z direction, respectively, forming the reflected sub-beams L1′ and L2′.

The optical detector 9 is located near the beam splitter 44c in such a way that the reception surface of the detector 9 faces the beam splitter 44c. The reception surface of the detector 9 is located on the optical paths of the reflected sub-beams L1′ and L2′ emitted from the splitter 44c. The detector 9 detects or measures the intensity of the sub-beams L1′ and L2′.

Next, the operation of the laser measuring device 100B according to the third embodiment of FIG. 13 is explained below. The initial laser beam L0 emitted from the laser source 3 enters the polarized beam splitter 44a, thereby forming the laser sub-beam L1 traveling in the +Z direction and the laser sub-beam L2 traveling in the +X direction.

The laser sub-beam L1 emitted from the splitter 44a passes through the beam splitter 44b, the quarter-wave plate 47a, and the aperture 2a of the mirror 1 to enter the corner cube prism 8a on the object 20. The linearly polarized sub-beam L1 is converted to the circularly polarized one by the plate 47a.

In the prism 8a, the sub-beam L1 is reflected twice by the reflecting planes 13a and 14a, and is turned from the +Z direction to the −Z direction (i.e., the opposite direction to the incoming one). At this time, the sub-beam L1 is shifted in the +X direction and thus, the sub-beam L1 travels in the −Z direction to reach the mirror 1 on the table 30. Since the sub-beam L1 is perpendicular to the reflecting plane of the mirror 1 the sub-beam L1 is reflected in the +Z direction by the mirror 1, forming the reflected sub-beam in L1′ traveling in the opposite direction to the incoming sub-beam L1 on the same optical path. The reflected sub-beam L1′ enters the prism 8a.

In the prism 8a, the reflected sub-beam L1′ is reflected twice by the reflecting planes 14a and 13a and is turned to the −Z direction. At this time, the sub-beam L1′ is shifted in the −X direction and thus, the sub-beam L1′ travels in the −Z direction toward the table 30. The sub-beam L1′ passes through the aperture 2a of the mirror 1 and the quarter-wave plate 47a to enter the beam splitter 44b on the table 30. The circularly polarized sub-beam L1′ is converted to the linearly polarized one by the plate 47a. This means that the sub-beam L1′ enters the splinter 44b as the vertically polarized beam. Thus, the sub-beam L1′ is reflected by the splitter 44b and is turned to the +X direction, entering the splitter 44c. The sub-beam L1′ passes through the splitter 44c without changing its direction, entering the optical detector 9.

As explained above, the laser sub-beam L1 formed by the splitter 44a forms the optical path OP1 from the splitter 44b to the mirror 1 by way of the corner cube prism 8a. The reflected sub-beam L1′ formed by the mirror 1 travels on the same path OP1 in the opposite direction. Thus, it is can be said that the sub-beam L1 makes a round trip along the path OP1. The intensity of the reflected sub-beam L1′ thus returned is detected or measured by the detector 9.

On the other hand, the laser sub-beam L2 emitted from the splitter 44a in the +X direction passes through the half-wave place 46a and is reflected by the mirror 5 to the +Z direction. Then, the sub-beam L2 enters the splitter 44c to pass through the same and then, pass through the quarter-wave plate 47b and the aperture 2b of the mirror, entering the corner cube prism 8b on the object 20. The linearly polarized sub-beam L2 is converted to the circularly polarized one by the plate 47b.

In the prism 8b, the sub-beam L2 is reflected twice by the reflecting planes 13b and 14b and is turned to the −Z direction. At this time, the sub-beam L2 is shifted in the +X direction and thus, the sub-beam L2 travels in the −Z direction to reach the mirror 1 on the table 30. Since the sub-beam L2 is perpendicular to the reflecting plane of the mirror 1, the sub-beam L2 is reflected in the +Z direction by the mirror 1, forming the reflected sub-beam L2′ traveling in the opposite direction to the incoming sub-beam L2 on the same optical path. The reflected sub-beam L2′ enters the prism 8b.

In the prism 8b, the reflected sub-beam L2′ is reflected twice by the reflecting planes 14b and 13b and is turned to the −Z direction. At this time, the sub-beam L2′ is shifted in the −X direction and thus, the sub-beam L2′ travels in the −Z direction toward the table 30. The sub-beam L2′ passes through the aperture 2b of the mirror 1 and the quarter-wave plate 47b to enter the beam splitter 44c on the table 30. The circularly polarized sub-beam L2′ is converted to the linearly polarized one by the plate 47b. This means that the sub-beam L2′ enters the splitter 44c as the horizontally polarized beam. Thus, the sub-beam L2′ is turned from the −Z direction to the +X direction by the splitter 44c, entering the optical detector 9.

As explained above, the laser sub-beam L2 formed by the splitter 44a forms the optical path OP2 from the splitter 44c to the mirror 1 by way of the corner cube prism 8b. The reflected sub-beam L2′ formed by the mirror 1 travels on the same path OP2 in the opposite direction. Thus, it can be said that the sub-beam L2 makes a round trip along the path OP2. The intensity of the reflected sub-beam L2′ thus returned is detected or measured by the detector 9.

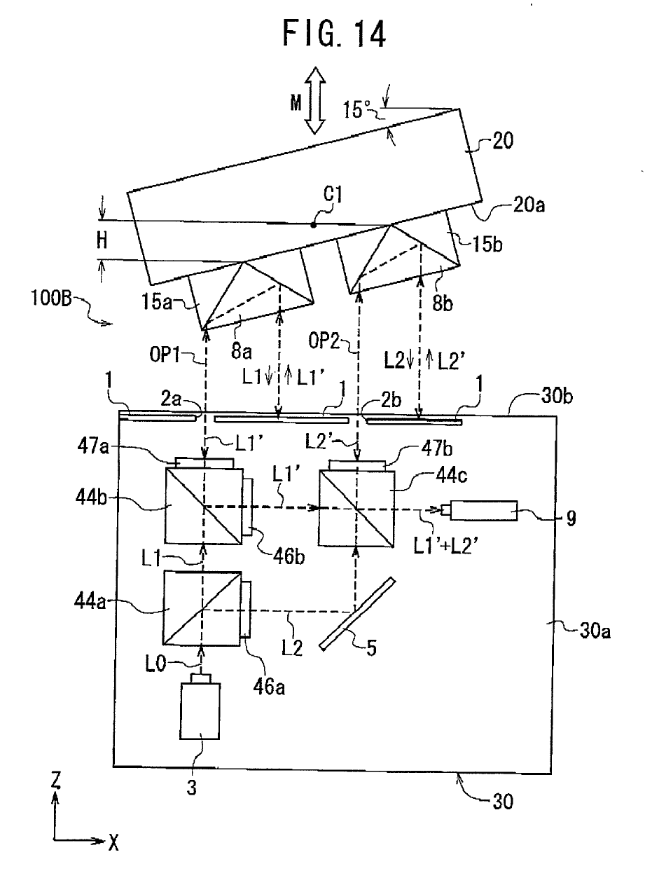

If the object 20 is moved or displaced along the M direction from the stationary state (i.e., the initial state) shown in FIG. 13, the sum of the optical paths of the incident sub-beam L1 and the reflected sub-beam L1′ (which is defined as the first overall optical path) varies and at the same time, the sum of the optical paths of the incident sub-beam 12 and the reflected sub-beam L2′ (which is defined as the second overall optical path) varies as well. If yawing occurs during this moving operation of the object 20, as shown in FIG. 14, the prisms 8a and 8b are tilted with the object 20, resulting in a difference between the lengths of rhe first and second overall optical paths corresponding to the displacement or shift H of the object. At this time, the resultant change of the second optical path is four times the resultant change of the first optical path. Accordingly, interference occurs between the sub-beams L1′ and L2′ and the intensity of the interference beam is detected by the detector 9. As a result, the yawing angle of the object 20 with respect to the table 30 can be measured using a known method.

Concretely, the yawing angle is calculated in the following way.

Here, it is supposed that the reflected sub-beams L1′ and L2′ with equal wavelengths λ have amplitudes a1 and a2, respectively, and that the first and second overall optical path lengths are defined as x1 and x2, respectively. In this case, the waveforms u1 and u2 of the sub-beams L1′ and L2′ are given by the following equations (1) and (2), respectively.

$$\begin{matrix}u1 = a1 \cdot cos ( 2 π \cdot \frac{x1}{λ} - ω t ) & ( 1 ) \\ u2 = a2 \cdot cos ( 2 π \cdot \frac{x2}{λ} - ω t ) & ( 2 )\end{matrix}$$

The intensity I off the interference bearn detected is given by the square of the amplitude and thus, it is expressed as

$$\begin{matrix}I = {( u1 + u2 )}^{2} \\ = {a1}^{2} + {a2}^{2} + 2 \cdot a1 \cdot a2 \cdot cos \{ \frac{2 π}{λ} \cdot ( x2 - x1 ) \}\end{matrix} \qquad ( 3 )$$

In the equation (3), the term (x2−x1) is the difference of the second optical path from the first optical path. Therefore, the relationship between the difference and the displacement or shift H of the two corner cube prisms 8a and 8b is expressed as follows.

x2−x1=4H (4)

By substituting the equation (4) into the equation (3), the following equation (5) is given.

$$I = {a1}^{2} + {a2}^{2} + 2 \cdot a1 \cdot a2 \cdot cos ( 8 π \cdot \frac{H}{λ} ) \qquad ( 5 )$$

As seen from the equation (5), the intensity I of the interference beam represents a sinusoidal change at the period of H=λ/4.

Accordingly, by counting the period (i.e., the repetition times) N of the varying intensity I of the interference beam while the yawing angle is changing, the following equation (6) gives the shift or displacement H.

$$H = N \cdot \frac{λ}{4} \qquad ( 6 )$$

Thereafrer, if the interval or distance d of the corner cube prisms 8a and 8b (i.e., the two sub-beams L1′ and L2′) is measured in advance, the yawing angle R is given by the following equation (7).

$$\begin{matrix}R = {tan}^{- 1} ( \frac{H}{d} ) \\ = {tan}^{- 1} ( \frac{N \cdot λ}{4 \cdot d} )\end{matrix} \qquad ( 7 )$$

As seen from the equation (7), if the interval or distance d of the prisms 8a and 8b is increased, the shift H of the prisms 8a and 8b due to yawing is enhanced, which increases the repetition number N of the intensity change of the interference beam. As a result, the resolving power of the device 100 B can be improved.

In addition, it has been well known that the resolving power rises with the decreasing wavelength X of the sub-beams L1′ and L2′.

It is obvious that the laser measuring device 100B according to the fourth embodiment have the same advantages as those in the device 100 according to the first embodiment.

Specifically, if the object 20 is displaced with yawing, the corner cube prisms 8a and 8b are tilted with the object 20. Thus, as seen from FIG. 14, the sub-beams L1 and L2 are reflected by the reflecting planes 13a and 14a and 13b and 14b at the shifted points in the +X direction in the prisms 8a and 8b compared with the case where no yawing occurs. However, the incoming sub-beams L1 and L2 reach the mirror 1 perpendicularly and then, they are reflected by the mirror 1 to the +Z direction in the same way as the case where no yawing occurs, forming the reflected sub-beam Ll′ and L2′ traveling on the optical paths OP1 and OP2 so the prisms 8a and 8b, respectively.

As a result, like the case where no yawing is present, the reflected laser sub-beams L1′ and L2′ traveling toward the optical detector 9 can be received by the detector 9 even it yawing of the object 20 exists. In other words, the shift or change of the sub-beams L1′ and L2′ can be eliminated or suppressed.

For example, as shown in FIG. 14, even if specific yawing of the object 20 occurs around the axis C1 on the object 20 at a large yawing angle of 15°counterclockwise, the reflected sub-beams L1′ and L2′ can be surely received by the detector 9. This means that the measurement is possible even in such the case. If the yawing angle increases further (e.g., approximately 30°to 40°), the measurement is possible as well. Since the positional adjustment of the optical detector required in the prior-art laser measuring device 200 is unnecessary, the measurement time is reduced.

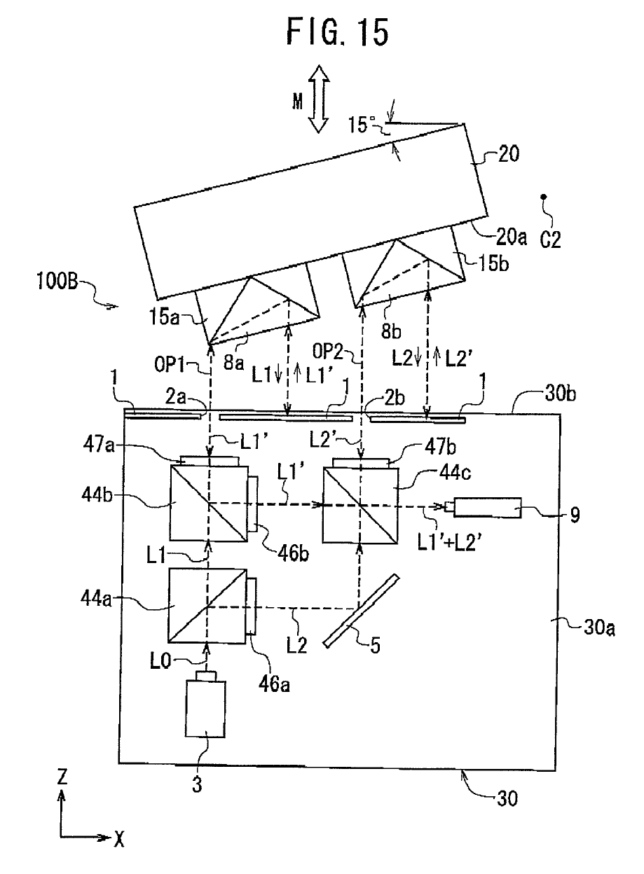

As shown in FIG. 15, even if specific yawing of the object 20 occurs around the axis C2 outside the object 20 at a large yawing angle of 15°counterclockwise, the reflected sub-beams L1′ and L2′ are substantially the same as the case where no yawing occurs. Thus, the measurement is possible even in such the case. Since the positional readjustment of the corner cube prisms required in the prior-art laser measuring device 200 is unnecessary, the measurement time is reduced, Also, no additional plate is necessary for attaching the corner cube prisms and thus, the measurement accuracy degradation does no: occur due to the additional plate.

Moreover, the sub-beam L1 makes a round trip along the optical path OP1 between the beam splitter 44b and the mirror 1 by way of the corner cube prism 8a. The sub-beam L2 makes a round trip along the optical path OP2 between the beam splitter 44c and the mirror 1 by way of the corner cube prism 8b. Accordingly, the difference between the lengths of the optical paths OP1 and OP2 is twice as much as the prior-art laser measuring device 200. As a result, resolving power in measurement is enhanced.

Since the positional shift of the sub-beams L1′ and L2′ with respect to the detector 9 is substantially zero in spite of yawing, the distance d between the corner cube prisms 8a and 8b can be increased as desired. This enhances the resolving power in measurement as well.

The yawing angle is calculated by measuring the repetition number N of the interference beam intensity and by substituting the repetition number N thus measured into the above-described equation (7). Accordingly, there is an additional advantage that the yawing angle measurement can be performed with a simpler circuitry than that required for the device 100 of the first embodiment.

Like the device 100′ according to the second embodiment shown in FIG. 11, if the combination of the laser source 3, the polarized beam splitters 44a, 44b, and 44c, the half-wave plates 46a and 46b, the quarter-wave plates 47a and 47b, the mirrors 5 and 1, and the detector 9 are mounted on the side face 30c of the table 30, the pitching angle can be measured instead of the yawing angle.

### VARIATIONS

It is needless to say that the invention is not limited to the above-described first to fourth embodiments. Various change may be applicable to the invention.

For example, the laser measuring devices 100 and 100′ of the first and second embodiments may be combined together In this case, the yawing and pitching angles can be measured in the same device.

The displacement error measuring section 50 in the device 100A of the third embodiment may be canceled, where the mirror 25 in the displacement measuring section 51 may be replaced with another laser source. In this case, the device is used for measuring the displacement only of the object 20.

The displacement error measuring section 50 in the device 100A of the third embodiment and the laser measuring device 100B of the fourth embodiment may be combined together.

Although the corner cube prisms 8a and 8b (and 8c) are used in the above-described first to fourth embodiments, any other optical reflection element may be used instead of the prisms 8a and 8b (and 8c) if it reflects an incident optical beam to a direction parallel to the incident beam. For example, an ordinary prism or a mirror may be used for this purpose.

While the preferred forms of the present invention has been described, it is to be understood that modifications will be apparent to those skilled in the art without departing from the spirit of the invention. The scope of the present invention, therefore, is to be determined solely by the following claims.

What is claimed is:

1. A laser measuring device for optically measuring a displacement, or a yawing or pitching angle of a member with respect to another member with a laser beam;
the device comprising:
(a) a laser source for emitting a laser beam; the laser source designed to be mounted on a first member;
(b) a beam splitter for splitting the laser beam into incident laser sub-beams;
the beam splitter designed to be mounted on the first member;
(c) a first plurality of optical reflectors for reflecting the respective incident sub-beams from the beam splitter to form a first plurality of reflected sub-beams;
the first plurality of optical reflectors being designed to be mounted on a second member;
the second member being apart from the first member;
(d) a second optical reflector for reflecting the first plurality of reflected sub-beams to form a second plurality of reflected sub-beams toward the first plurality of optical reflectors;
the second optical reflector being designed to be mounted on the first member;
the second plurality of reflected sub-beams being reflected by the first plurality of optical reflectors to form a third plurality of reflected sub-beams toward the beam splitter;
the third plurality of reflected sub-beams traveling along optical paths of the respective incident laser sub-beams; and
(e) an optical detector for detecting the third plurality of laser sub-beams;
the detector being designed to be mounted on the first member.

2. The device according to claim 1, wherein each of the first plurality of optical reflectors is an optical element that reflects an incident beam and turn the incident beam to an opposite direction to the incident beam.

3. The device according to claim 1, wherein each of the first plurality of optical reflectors has a first reflecting plane that receives a corresponding one of the incident laser sub-beams from the beam splitter and a second reflecting plane that is opposed to the second optical reflector.

4. The device according to claim 1, wherein the first plurality of reflected sub-beams formed by the first plurality of optical reflectors are incident perpendicularly on corresponding reflecting planes of the second optical reflector.

5. The device according to claim 1, wherein the third plurality of reflected sub-beams toward the beam splitter are approximately coaxial with the respective incident laser sub-beams.

6. The device according to claim 1, wherein a first one of the incident sub-beams travels to a corresponding one of the first plurality of optical reflectors along a first optical path by way of no mirror means;
and wherein a second one of the incident sub-beams travels to a corresponding one of the first plurality of optical reflectors along a second optical path by way of mirror means.

7. The device according to claim 6, wherein after a first one of the third plurality of reflected sub-beams reaches the beam splitter, the first one of the third plurality of reflected sub-beams is turned to the optical detector and enters the same.

8. The device according to claim 6, wherein after a second one of the third plurality of reflected sub-beams reaches the beam splitter, the second one of the third plurality of reflected sub-beams passes through the splitter without changing its direction and enters the optical detector.

9. The device according to claim 6, wherein an interference beam caused by length difference between the first and second optical paths is detected, thereby measuring a yawing or pitching angle of the second member with respect to the first member.

10. The device according to claim 1, wherein the second optical reflector has openings allowing the respective incident laser sub-beams emitted from the laser source to pass through the same toward the first plurality of optical reflectors.

11. The device according to claim 1, wherein the incident laser sub-beams emitted from the laser source travel to the first plurality of optical reflectors by way of corresponding quarter-wave plates.

12. The device according to claim 1, further comprising a displacement measuring section provided on the first member;
wherein the displacement measuring section measures a displacement of the second member with respect to the first member using the laser beam emitted from the laser source.

13. The device according to claim 1, wherein the second optical reflector is an optical element with a flat reflecting plane;
and wherein the second plurality of reflected sub-beams travel in an opposite direction to the first plurality of reflected sub-beams due to reflection on the flat reflecting plane of the optical element.

14. A laser measuring method for optically measuring a displacement, or a yawing or pitching angle of a member with respect to another member with a laser beam;
the method comprising:
(a) forming a laser beam on a first member;
(b) splitting the laser beam into incident laser sub-beams on the first member;
(c) reflecting the respective incident sub-beams by a first plurality of optical reflectors mounted on a second member, forming a first plurality of reflected sub-beams;
the second member being apart from the first member;
(d) reflecting the first plurality of reflected sub-beams by a second optical reflector mounted on the first member, forming a second plurality of reflected sub-beams toward the first plurality of optical reflectors;
(e) reflecting the second plurality of reflected sub-beams by the first plurality of optical reflectors, forming a third plurality of reflected sub-beams toward the beam splitter;
the third plurality of reflected sub-beams traveling along optical paths of the respective incident laser sub-beams; and
(f) detecting the third plurality of laser sub-beams by an optical detector mounted on the first member.

15. The method according to claim 14, wherein each of the first plurality of optical reflectors is an optical element that reflects an incident beam and turn the incident beam to an opposite direction to the incident beam.

16. The method according to claim 14, wherein each of the incident laser sub-beams from the beam splitter is reflected by a first reflecting plane of a corresponding one of the first plurality of optical reflectors;
and wherein the second optical reflector is opposed to a second reflecting plane of a corresponding one of the first plurality of optical reflectors.

17. The method according to claim 14, wherein the first plurality of reflected sub-beams formed by the first plurality of optical reflectors are incident perpendicularly on corresponding reflecting planes of the second optical reflector.

18. The method according to claim 14, wherein the third plurality of reflected sub-beams toward the beam splitter are approximately coaxial with the respective incident laser sub-beams.

19. The method according to claim 14, wherein a first one of the incident sub-beams travels to a corresponding one of the first plurality of optical reflectors along a first optical path by way of no mirror means;
and wherein a second one of the incident sub-beams travels to a corresponding one of the first plurality of optical reflectors along a second optical path by way of mirror means.

20. The method according to claim 19, wherein after a first one of the third plurality of reflected sub-beams reaches the beam splitter, the first one of the third plurality of reflected sub-beams is turned to the optical detector and enters the same.

21. The method according to claim 19, wherein after a second one of the third plurality of reflected sub-beams reaches the beam splitter, the second one of the third plurality of reflected sub-beams passes through the splitter without changing its direction and enters the optical detector.

22. The method according to claim 19, wherein the optical detector detects an interference beam caused by length difference between the first and second optical pachs, thereby measuring a yawing or pitching angle of the second member with respect to the first member.

23. The method according to claim 14, wherein the second optical reflector has openings allowing the respective incident laser sub-beams emitted from the laser source to pass through the same toward the first plurality of optical reflectors.

24. The method according to claim 14, wherein the incident laser sub-beams emitted from the laser source travel to the first plurality of optical reflectors by way of corresponding quarter-wave plates.

25. The method according to claim 14, further comprising a step of providing a displacement measuring section on the first member;
wherein the displacement measuring section measures a displacement of the second member with respect to the first member using the laser beam emitted from the laser source.

26. The method according to claim 14, wherein the second optical reflector is an optical element with a flat reflecting plane;
and wherein the second plurality of reflected sub-beams travel in an opposite direction to the first plurality of reflected sub-beams due to reflection on the flat reflecting plane of the optical element.

27. A laser measuring device for optically measuring a displacement, or a yawing or pitching angle of a member with respect to another member with a laser beam;
the device comprising:
(a) a laser source for emitting a laser beam;
the laser source designed to be mounted on a first member;
(b) a first beam splitter for splitting the laser beam into incident laser sub-beams;
the first beam splitter designed to be mounted on the first member;
(c) a second beam splitter for directing a first one of the incident laser sub-beams to a second member;
the second beam spliater designed to be mounted on the first member;
the second member being apart from the first member;
(d) a third beam splitter for directing a second one of the incident laser sub-beams to the second member;
the third beam splitter designed to be mounted on the first member;
(e) a first optical reflector for reflecting the first one of the incident laser sub-beams to form a first reflected sub-beam;
the first optical reflector being designed to be mounted on the second member;
(f) a second optical reflector for reflecting the second one of the incident laser sub-beams to form a second reflected sub-beam;
the second optical reflector being designed to be mounted on the second member;
(g) a third optical reflector for reflecting the first and second reflected sub-beams to form third and fourth reflected sub-beams toward the first and second optical reflectors, respectively;
the third optical reflector being designed to be mounted on the first member;
the third and fourth reflected sub-beams being reflected by the first and second optical reflectors to form fifth and sixth reflected sub-beams toward the second and third beam splitters, respectively;
the fifth and sixth reflected sub-beams traveling along optical paths of the first and second ones of the incident laser sub-beams, respectively; and
(h) an optical detector for detecting the fifth and sixth laser sub-beams;
the detector being designed to be mounted on the first member.

28. The device according to claim 27, wherein each of the first and second optical reflectors is an optical element that reflects an incident beam and turn the incident beam to an opposite direction to the incident beam.

29. The device according to claim 27, wherein each of the first and second optical reflectors has a first reflecting plane that receives a corresponding one of the first and second ones of the incident laser sub-beams and a second reflecting plane that is opposed to the third optical reflector.

30. The device according to claim 27, wherein the first and second reflected sub-beams formed respectively by the first and second optical reflectors are incident perpendicularly on corresponding reflecting planes of the third optical reflector.

31. The device according to claim 27, wherein the fifth and sixth reflected sub-beams are approximately coaxial with the first and second ones of the incident laser sub-beams, respectively.

32. The device according to claim 27, wherein the first one of the incident sub-beams travels to the first optical reflector along a first optical path by way of no mirror means;
and wherein the second one of the incident sub-beams travels to the second optical reflector along a second optical path by way of mirror maeans.

33. The device according to claim 32, wherein after the fifth reflected sub-beam reaches the second beam splitter, the fifth reflected sub-beam enters the optical detector by way of the third beam splitter.

34. The device according to claim 32, wherein after the sixth reflected sub-beam reaches the third beam splitter, the sixth reflected sub-beam enters the optical detector without passing though the second beam splitter.

35. The device according to claim 32, wherein an interference beam caused by length difference between the first and second optical paths is detected, thereby measuring a yawing or pitching angle of the second member with respect to the first member.

36. The device according to claim 27, wherein the third optical reflector on the first member has openings that allow the first and second ones of the incident laser sub-beams to pass through the same toward the first and second optical reflectors on the second member, respectively.

37. The device according to claim 27, wherein the second one of the incident laser sub-beam emitted from the first beam splitter enters the third beam splitter by way of a half-wave plate.

38. The device according to claim 27, wherein the first one of the incident laser sub-beam emitted from the first beam splitter travels toward the second member by way of a quarter-wave plate.

39. The device according to claim 27, wherein afuer the fifth reflected sub-beam enters the second beam splitter, the fifth reflected sub-beam travels to the third beam splitter by way of a half-wave plate.

40. The device according to claim 27, wherein the second one of the incident laser sub-beam emitted from the third beam splitter travels toward the second member by way of a quarter-wave plate.

41. The device according to claim 27, further comprising a displacement measuring section provided on the first member;
the displacement measuring section measures a displacement of the second member with respect to the first member using the laser beam emitted from the laser source.

42. The device according to claim 27, wherein the third optical reflector is an optical element with a flat reflecting plane;
and wherein the third anti fourth reflected sub-beams travel in an opposite direction to the first and second reflected sub-beams due to reflection on the flat reflecting plane of the optical element, respectively.

43. The device according to claim 27, wherein the third optical reflector in an optical element with a flat reflecting plane;
and wherein the third and fourth reflected sub-beams travel in an opposite direction to the first and second reflected sub-beams due to reflection on the flat reflecting plane of the optical element, respectively.

44. A laser measuring method for optically measuring a displacement, or a yawing or pitching angle of a member with respect to another member with a laser beam;
the method comprising:
(a) forming a laser beam on a first member;
(b) splitting the laser beam into incident laser sub-beams on the first member;
(c) directing a first one of the incident laser sub-beams to a second member;
the second beam splitter designed to be mounted on the first member;
the second member being apart from the first member;
(d) directing a second one of the incident laser sub-beams to the second member;
the third beam splitter designed to be mounted on the first member;
(e) reflecting the first one of the incident laser sub-beams by a first optical reflector, forming a first reflected sub-beam;
the first optical reflector being mounted on the second member;
(f) reflecting the second one of the incident laser sub-beams by a second optical reflector, forming a second reflected sub-beam;
the second optical reflector being mounted on the second member;
(g) reflecting the first and second reflected sub-beams by a third optical reflector, forming third and fourth reflected sub-beams toward the first and second optical reflectors, respectively;
the third optical reflector being mounted on the first member;
(h) reflecting the third and fourth reflected sub-beams by the first and second optical reflectors, forming fifth and sixth reflected sub-beams toward the second and third beam splitters, respectively;
the fifth and sixth reflected sub-beams traveling along optical paths of the first and second ones of the incident laser sub-beams, respectively; and
(i) detecting the fifth and sixth laser sub-beams by an optical detector mounted on the first member.

45. The method according to claim 44, wherein each of the first and second optical reflectors is one selected from the group consisting of a prism, a mirror, and a corner cube prism.

46. The method according to claim 44, wherein each of the first and second optical reflectors has a first reflecting plane that receives a corresponding one of the first and second ones of the incident laser sub-beams and a second reflecting plane that is opposed to the third optical reflector.

47. The method according to claim 44, wherein the first and second reflected sub-beams formed respectively by the first and second optical reflectors are incident perpendicularly on corresponding reflecting planes of the third optical reflector.

48. The method according to claim 44, wherein the fifth and sixth reflected sub-beams are approximately coaxial with the first and second ones of the incident laser sub-beams, respectively.

49. The method according to claim 44, wherein the first one of the incident sub-beams travels to the first optical reflector along a first optical path by way of no mirror means;
and wherein the second one of the incident sub-beams travels to the second optical reflector along a second optical path by way of mirror means.

50. The method according to claim 49, wherein after the fifth reflected sub-beam reaches the second beam splitter, the fifth reflected sub-beam enters the optical detector by way of the third beam splitter.

51. The method according to claim 49, wherein after the sixth reflected sub-beam reaches the third beam splitter, the sixth reflected sub-beam enters the optical detector without passing though the second beam splitter.

52. The method according to claim 49, wherein an interference beam caused by length difference between the first and second optical paths is detected, thereby measuring a yawing or pitching angle of the second member with respect to the first member.

53. The method according to claim 44, wherein the third optical reflector on the first member has openings that allow the first and second ones of the incident laser sub-beams to pass through the same toward the first and second optical reflectors on the second member, respectively.

54. The method according to claim 44, wherein the second one of the incident laser sub-beam emitted from the first beam splitter enters the third beam splitter by way of a half-wave plate.

55. The method according to claim 44, wherein the first one of the incident laser sub-beam emitted from the first beam splitter travels toward the second member by way of a quarter-wave plate.

56. The method according to claim 44, wherein after the fifth reflected sub-beam enters the second beam splitter, the fifth reflected sub-beam travels to the third beam splitter by way of a half-wave plate.

57. The method according to claim 44, wherein the second one of the incident laser sub-beam emitted from the third beam splitter travels toward the second member by way of a quarter-wave plate.

58. The method according to claim 44, further comprising a displacement measuring section provided on the first member;
the displacement measuring section measures a displacement of the second member with respect to the first member using the laser beam emitted from the laser source.

59. The methqd according to claim 44, wherein the third optical reflector is an optical element with a flat reflecting plane;
and wherein the third and fourth reflected sub-beams travel in an opposite direction to the first and second reflected sub-beams due to reflection on the flat reflecting plane of the optical element, respectively.
